(19) United States
(12) Patent Application Publication
(10) Pub. No.: US 2025/0384499 A1
(43) Pub. Date: Dec. 18, 2025

(54) APPLICATION ASSISTANCE AND ASSOCIATED SYSTEMS, METHODS, AND NON-TRANSITORY COMPUTER-READABLE MEDIA

(71) Applicant: Syntactic Sugar Inc., Atlanta, GA (US)

(72) Inventor: Dwight Frederick, Atlanta, GA (US)

(73) Assignee: Syntactic Sugar Inc., Atlanta, GA (US)

(21) Appl. No.: 19/238,118

(22) Filed: Jun. 13, 2025

Related U.S. Application Data
(60) Provisional application No. 63/660,191, filed on Jun. 14, 2024.
(60) Provisional application No. 63/794,038, filed on Apr. 24, 2025.

(51) Int. Cl. G06Q 50/18; G06F 40/143; G06F 40/40

(52) U.S. Cl. CPC G06Q 50/18; G06F 40/143; G06F 40/40

(57) ABSTRACT

An application assistance system may include a browser extension and a server. The browser extension may identify an application to be filled out or completed at a website, obtain application questions from the application, and provide the application questions to the server. The server may generate another application that includes the application questions. The server may allow a user to provide documents that may be used to generate answers to the application questions, and request that an artificial intelligence model system generate the answers using the provided documents or a subset thereof. The user may view the generated answers and modify or replace them. The user may return to the website, where the browser extension may determine that there are generated answers to the application. The browser extension may, upon request from the user, automatically provide the answers to the application at the website.

### CROSS-REFERENCE TO RELATED APPLICATIONS

This application claims priority to and seeks the benefit of U.S. Provisional Patent Application No. 63/660,191, filed on Jun. 14, 2024, and entitled “APPLICATION ASSISTANCE AND ASSOCIATED SYSTEMS, METHODS, AND NON-TRANSITORY COMPUTER-READABLE MEDIA” and U.S. Provisional Patent Application No. 63/794,038, filed on Apr. 24, 2025, and entitled “APPLICATION ASSISTANCE AND ASSOCIATED SYSTEMS, METHODS, AND NON-TRANSITORY COMPUTER-READABLE MEDIA.” Each of the foregoing applications is incorporated by reference herein in its entirety.

### TECHNICAL FIELD

The present disclosure relates in general to assisting with applications and to providing information about applications, and in particular to assisting individuals or organizations fill out or complete grant applications and to providing such individuals or organizations with information about grant applications.

### BACKGROUND

Applications may require applicants to provide the same or similar information for each application. For example, a person working for a non-profit organization may write grant applications to numerous funding organizations requesting that the funding organizations provide grants to fund the non-profit organization's mission or activities. The grant applications often include the same or similar questions that the person has to answer. The person typically has to copy and paste answers from word processing documents, spreadsheets, and web pages to each grant application in order to complete the grant applications.

Such manual copying and pasting of information is tedious and labor-intensive. The time required to fill out grant applications prevents the person from devoting their time to the non-profit organization's mission and activities. Other types of applications, such as education applications, employment applications, housing applications, and government applications pose the same problems for applicants.

Moreover, after submitting an application, the person may find it difficult to track the application and its status. If the person submits or is associated with an organization that submits multiple applications, the difficulties compound. Accordingly, time spent tracking applications may detract from the person or organization's mission and activities.

### SUMMARY

An application assistance system that may streamline the process of filling out applications. Users may utilize an application assistance browser extension to import applications from application websites into an application assistance server. For an application, a user may upload relevant documents that may be used to generate appropriate answers. Artificial intelligence (AI) techniques, such as Retrieval Augmented Generation (RAG), may be used to generate answers to application questions. The application assistance browser extension may also automatically populate answers directly into the application on the application website, reducing the burden on the user.

When the user requests AI-generated answers, the application assistance server may send the provided documents and inputs to an AI model system, which may produce answers to the application questions using the provided documents. The user has control over these AI-generated answers, with the ability to review, modify, and save them before submission. Once finalized, the user may return to the original application website, and the application assistance browser extension may facilitate the automatic transfer of the AI-generated answers back into the application.

Beyond assistance with filling out or completing applications, the application assistance server may offer additional functionalities such as application tracking. Users may mark application statuses and keep track of submissions within an organized dashboard provided by the application assistance server. The application assistance system may be especially useful for grant applications, as users can specify expected funding amounts and access insights about various applications related to them or their organization. These and other features of the application assistance system ensure a more efficient and informed application process for users.

### BRIEF DESCRIPTION OF THE DRAWINGS

FIG. 1 is a block diagram depicting an example environment in which an application assistance system may operate in some embodiments.

FIG. 2 depicts a block diagram of an application assistance server and an application assistance browser extension of the application assistance system in some embodiments.

FIGS. 3A and 3B depict example user interfaces provided by the application assistance system in some embodiments.

FIG. 4 depicts a method for generating answers to application questions in some embodiments.

FIGS. 5A-5C depict example user interfaces provided by the application assistance system for obtaining application questions from applications in some embodiments.

FIGS. 6A-6I depict example user interfaces provided by the application assistance system for answering application questions in some embodiments.

FIGS. 7A-7D depict example user interfaces provided by the application assistance system for providing application question answers to applications in some embodiments.

FIG. 8 is a block diagram depicting another example environment in which the application assistance system may operate according to some embodiments.

FIG. 9 depicts another method for generating answers to application questions according to some embodiments.

FIGS. 10A-10C depict example grant application questions and example user interfaces provided by the application assistance system in some embodiments.

FIGS. 11A-11E depict example software code that the application assistance browser extension of the application assistance system may utilize to perform various functions in some embodiments.

FIGS. 12A and 12B depict example software code that the application assistance server of the application assistance system may utilize to generate inputs to an artificial intelligence model system based on application questions and documents and receive responses to the inputs in some embodiments.

FIG. 13 depicts a block diagram of an example digital device in some embodiments.

Throughout the drawings, like reference numerals will be understood to refer to like parts, components, and structures.

### DETAILED DESCRIPTION

Existing systems for assisting with applications cannot obtain application questions from an application form at an application website and import the application questions into another application form. Moreover, existing systems cannot automatically provide answers to the application questions in the application form at the application website. Such systems typically require users to manually copy answers to application questions into the application form at the application website.

Described herein is an application assistance system that provides technical solutions to these and other technical problems. The application assistance system may allow a user to utilize an application assistance browser extension to import an application at an application website into an application assistance server. The application assistance system may also allow the user to utilize artificial intelligence (AI) or machine learning (ML) technologies to assist with filling out or completing the application at the application assistance server. The application assistance system may also allow the user to utilize the application assistance browser extension to automatically fill out or complete the application at the application website.

The application assistance browser extension may identify an application at the application website, obtain application questions from the application, and provide the application questions to the application assistance server. The application assistance server may generate another application that includes the application questions. The application assistance server may allow the user to provide and specify documents that may be used to generate answers to the application questions.

The application assistance server may receive a request from the user to have an AI model system generate answers to the application questions. The application assistance server may provide the specified documents to the AI model system along with inputs to request that the AI model system generate answers to the application questions. The application assistance server may receive answers from the AI model system and provide the answers in the generated application at the application assistance server. The user may view the answers, modify the answers, and save the answers as originally generated or as modified. The application assistance server may store the answers.

The user may return to the application at the application website. The application assistance browser extension may determine that the application assistance server stores answers to the application questions. The application assistance browser extension may receive a request from the user to provide the answers to the application at the application website. The application assistance browser extension may automatically provide the answers to the application.

The application assistance server may provide additional functionality. For example, the application assistance server may allow the user to specify a status of the application and track the status of the application. The application assistance server may also allow the user to specify other information about the application. For example, in the case of a grant application, the application assistance server may allow the user to specify an expected funding amount for the grant application. The application assistance server may store the status and the other information and provide the status and the other information for display to the user in a dashboard or other user interface. This may allow the user to obtain information quickly and easily about the application, as well as any other applications that the user or the organization of the user is associated with.

As described in more detail herein, the application assistance system provides technical solutions to various technical problems. One technical problem is that existing systems often struggle with accuracy, completeness, and contextual relevance. Traditional methods rely on predefined templates, keyword-based retrieval, or rule-based logic, which can lead to generic or incorrect responses, particularly when the application requires nuanced answers. Moreover, these systems frequently lack adaptability, failing to integrate new information dynamically. This results in inefficiencies, requiring manual intervention to correct and refine responses, which slows down processes and increases the likelihood of errors.

The application assistance system leverages Retrieval Augmented Generation (RAG) to address these shortcomings by dynamically retrieving relevant information and synthesizing it into coherent, contextually appropriate answers. Unlike traditional retrieval methods, RAG combines the strengths of information retrieval with generative models, ensuring responses are both factually grounded and linguistically natural. By pulling data from verified sources and structuring responses in real-time, the application assistance system reduces inaccuracies and minimizes reliance on static templates. Additionally, RAG enhances adaptability, allowing the application assistance system to refine answers based on updated data, making it particularly effective for complex applications where requirements and contextual information evolve.

This technical advancement significantly improves efficiency and reliability in applications requiring automated responses. By integrating retrieval with generative capabilities, the application assistance system mitigates common failures seen in conventional systems—such as outdated or incomplete responses—while reducing the need for human oversight. In practical terms, the application assistance system streamlines workflows, enhances decision-making processes, and ensures responses maintain a high level of accuracy and coherence, solving a longstanding technical problem in automated question-answering systems.

Another technical problem relates to identifying all the application questions at an application website that provides (or appears to provide) all the application questions in more than one web page (which may be referred to as a multi-page form). As described in more detail herein, one technical solution to this technical problem may involve the application assistance system utilizing the HTML DOM (Document Object Model) to obtain all of the application questions, even if the application questions span (or appear to span) more than one web page.

Another technical problem relates to identifying the portions of an application web page or pages that may include application questions. Numerous application web pages may include website elements, such as iframe elements, that may include application questions. Various iframe elements may be from different sources (for example, different websites) and may have different sizes or visibilities. As described in more detail herein, one technical solution to identifying portions of the application website that may include application questions may involve the application assistance system generating a data structure that includes all the iframe elements and filtering out iframe elements that are unlikely to include application questions.

Another technical problem relates to providing the application answers to the application form on the application web page at the application website. The application web page may span or appear to span more than one web page (for example, a multi-page form), and a submit button or similar element may be required to be selected in order to advance from one web page to the next web page. As described in more detail herein, one technical solution to this technical problem may involve the application assistance system automatically providing the answers to the application questions in one page and automatically selecting the submit buttons or similar elements to advance to the next web pages until the application questions are filled out with the answers on the web pages.

The technical solutions provided by the application assistance system facilitate numerous advantages. One advantage is that the application assistance system may obtain all the application questions in an application, even those that span (or appear to span) more than one web page. Another advantage is that the application assistance system may obtain application questions from websites other than the primary website that provides the application (for example, from application questions included in or embedded in iframes). Another advantage is that the application assistance system may provide answers to all the application questions in an application, even those that span (or appear to span) more than one web page.

Yet another advantage of the application assistance system is that a user may avoid having to frequently switch contexts (for example, from documents to applications and from applications to documents) while filling out the applications. The application assistance system may also reduce or minimize errors by having answers generated with the appropriate information obtained from or derived from the documents, and by automatically providing the answers to the application questions.

An example use case of the application assistance system may involve a person writing grant applications for a particular non-profit organization. The person may provide a variety of documents (proposals, budgets, mission statements, past reports, etc.) to the application assistance system to create a knowledge base for the particular non-profit organization or a particular project of the particular non-profit organization. Grant applications may often include the same or similar questions (for example, “What is your organization's mission?”), the answers to which may often be found in the documents or may be derived from the documents. As the person accesses a grant application at a grant application website in their browser, the application assistance browser extension may identify or detect the grant application. The application assistance browser extension may obtain the grant application questions from the grant application and provide the grant application questions to the application assistance server.

The application assistance server may receive the grant application questions and create another grant application that includes the grant application questions. The other grant application may be regarded as a duplicate or copy of the grant application at the grant application website. The application assistance server may obtain answers to the grant application questions from an AI model system utilizing Retrieval Augmented Generation (RAG). The AI model system may include or interface with one or more large language models that utilizes the project documents to answer the grant application questions. The application assistance server may receive the answers from the artificial intelligence model system and provide the answers to the other grant application. The user may then review, modify, or replace the answers. Once the user is satisfied with the answers, the user may return to the grant application at the grant application website. The user may then use the application assistance browser extension to have the application assistance browser extension automatically populate the form fields in the grant application with the answers. The application assistance system thus saves the person having to spend time writing answers to grant application questions or manually copying and pasting information from documents to grant applications.

Grant writers across all industries and sectors, non-profit organizations reliant on grant funding, and independent consultants specializing in grant proposal development may benefit from the application assistance system. For example, the application assistance system may be utilized to fill out or complete competitive grants, non-competitive grants (formula/entitlement grants), continuation grants, pass-through grants, planning grants, project grants, capacity-building grants, research grants, fellowship or scholarship grants, or cooperative agreements.

Although many examples described herein refer to assisting persons with filling out or completing grant applications, the application assistance system is not necessarily limited to such use cases. Rather, the application assistance system may be utilized for assistance in a wide variety of application types. For example, the application assistance system may be used to provide assistance with filling out or completing education applications such as college applications, filling out or completing employment applications, filling out or completing housing applications such as rental housing applications, filling out or completing government applications such as visa or citizenship applications, filling out or completing financial aid applications, filling out or completing loan applications, filling out or completing insurance applications, or filling out or completing business license applications. Without the application assistance system, a person filling out such an application may have to spend hours manually copying and pasting information from relevant documents (for example, financial statements in the case of loan applications, resumes in the case of employment applications, and essays or biographical information in the case of education applications). The application assistance system may obtain the application questions from the application, utilize the relevant documents to obtain answers to the application questions, and automatically provide the answers to the application questions. Accordingly, the application assistance system is applicable to providing assistance with filling out or completing various types of applications or forms.

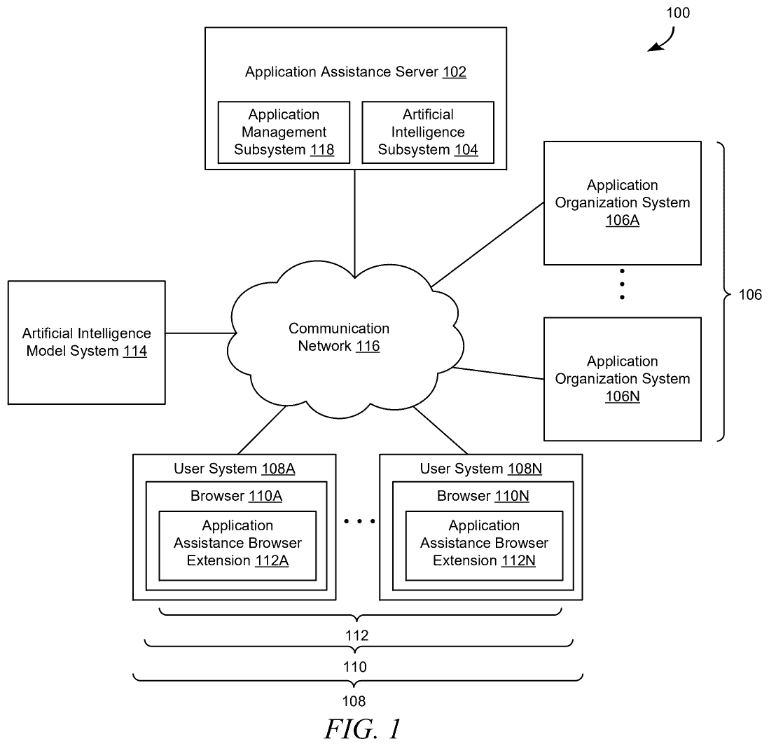

FIG. 1 is a block diagram depicting an example environment 100 in which the application assistance system may operate in some embodiments. The application assistance system may include an application assistance server 102 and an application assistance browser extension 112. The environment 100 may include an application organization system 106A through an application organization system 106N (referred to as an application organization system 106 or as application organization systems 106), a user system 108A through a user system 108N (referred to as a user system 108 or as user systems 108), an artificial intelligence model system 114, and a communication network 116. The application assistance server 102 includes an artificial intelligence subsystem 104 and an application management subsystem 118. The application organization system 106 may be operated or provided by an application organization. In the context of grant applications, an example of an application organization may be a funding organization that provides funds to non-profit organizations.

The user systems 108 may each include a browser 110 (shown individually as a browser 110A through a browser 110N). Each browser 110 may include an application assistance browser extension 112 (shown individually as an application assistance browser extension 112A through an application assistance browser extension 112N). The application assistance browser extension 112 may be a browser extension created using the Chrome Application Programming Interface (API). The application assistance system may include the application assistance server 102 and the application assistance browser extension 112. The application assistance system may also include other components not illustrated in FIG. 1.

The artificial intelligence model system 114 may provide or include artificial intelligence (AI) models with various capabilities. The artificial intelligence model system 114 may be provided by entities such as OpenAI, Google, Microsoft, and Meta. Such AI models may include large language models (also referred to as text generation models or generative artificial intelligence models) that have been trained to understand natural language text, software code, audio, images, or video. The large language models may receive natural language text, software code, audio, images or video as inputs and provide text, such as natural language text or software code, as outputs. Such AI models may also include models that can generate or modify audio, images or video, models that can convert text to speech or speech to text, and models that generate embeddings, such as vectorized embeddings, of documents or of portions of documents. The artificial intelligence model system 114 may provide access to AI models, such as large language models, via Application Programming Interfaces (APIs).

The application organization system 106 may provide an application website that is or includes a web page that is or includes an application. A user may utilize the browser 110 of the user system 108 to access the web page at the application website. When the user accesses the web page at the application website, the application assistance browser extension 112 may determine that the web page is or includes an application. The application assistance browser extension 112 may also identify application questions in the application. The application assistance browser extension 112 may obtain the application questions and provide the application questions to the application assistance server 102. The application assistance browser extension 112 may also obtain other information about the application, such as a name of the application, a deadline of the application, which (if any) application questions require answers, how the application questions are organized, and any other information that may be useful or necessary to fill out or complete the application.

The application assistance server 102 may receive the application questions from the application assistance browser extension 112 and generate another application that includes the application questions. The application assistance server 102 may provide the other application to the user at an application assistance website that the application management subsystem 118 provides. The application assistance website may allow the user to fill out or complete the other application by having the artificial intelligence model system 114 generate answers to the questions in the other application based on documents the user specifies.

The artificial intelligence subsystem 104 of the application assistance server 102 may generate inputs, including prompts, for the artificial intelligence model system 114, based on the application questions. The artificial intelligence subsystem 104 may provide the inputs and the documents to the artificial intelligence model system 114. The artificial intelligence model system 114 may utilize one or more large language models to generate one or more responses to the inputs based on the documents that are relevant to the application questions. The responses may include answers to the application questions. The artificial intelligence model system 114 may then provide the responses to the application assistance server 102.

The artificial intelligence subsystem 104 may receive the responses from the artificial intelligence model system 114. The application management subsystem 118 may provide the answers in the other application that the application assistance website provides and allow the user to modify the answers in the other application. Once the user has completed the application, the user may mark the status of the application. The user may then return to the application website to the web page that includes the application. The user may request that the application assistance browser extension 112 automatically provide the answers to the application questions in the application on the web page. For example, the application assistance browser extension 112 may automatically fill out form fields of grant application questions on the web page with the answers to the grant application questions.

As described in more detail herein, the application management subsystem 118 may provide other functionality through the application assistance website. For example, the application management subsystem 118 may generate and store applications that include the questions obtained by the application assistance browser extension 112, provide user interfaces that allow users to fill out applications, provide a dashboard that provides information on applications, and allow users to manage documents used by the artificial intelligence subsystem 104 to have answers generated for applications. As another example, the application management subsystem 118 may allow users to modify answers to application questions that the artificial intelligence model system 114 generated and collaborate with other users to fill out or complete applications. The application management subsystem 118 may provide an organization and the organization users with a centralized location where the organization and the organization users may monitor the applications that the organization has filled out or completed or is in the process of filling out or completing. The application assistance server 102 may thus alleviate the burdens on the organization and the organization users of having to track applications across disparate application websites.

In some embodiments, the communication network 116 may represent one or more computer networks (for example, local area networks (LANs), wide area network (WANs), the Internet, or the like). The communication network 116 may provide or facilitate communication between any of the application assistance server 102, the application organization systems 106, the user systems 108, and the artificial intelligence model system 114. In some implementations, the communication network 116 comprises computer devices, routers, cables, or other network topologies. Devices or components of the communication network 116 may transmit and receive data wirelessly or using wired connections. In various embodiments, the communication network 116 may comprise the Internet, one or more networks that may be public, private, IP-based, non-IP based, and so forth.

It is to be understood that the environment 100 is exemplary. Environments in which the application assistance system may operate may include fewer or more systems or devices than the environment 100. For example, the application assistance system may store or obtain documents in or from various file hosting services in addition to or as an alternative to storing documents at the application assistance server 102 or the artificial intelligence model system 114 or obtaining documents from the user systems 108.

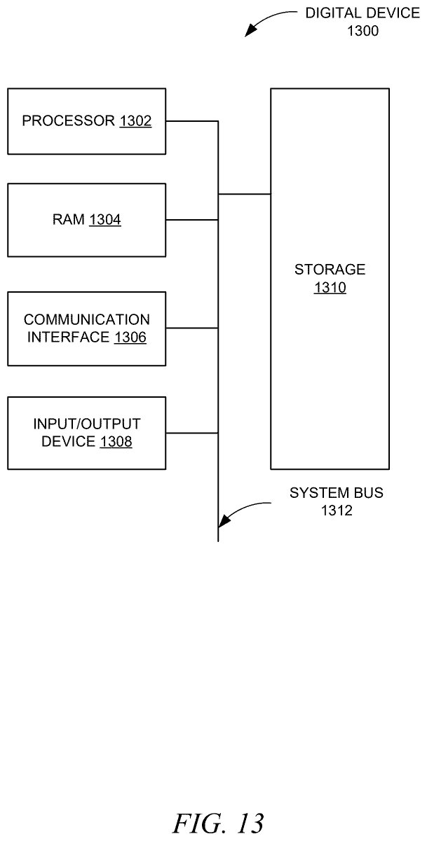

Each of the application assistance server 102, the application organization system 106, the user system 108, and the artificial intelligence model system 114 may be or include any number of digital devices. A digital device is any device with at least one processor and memory. Digital devices are discussed further herein, for example, with reference to FIG. 13.

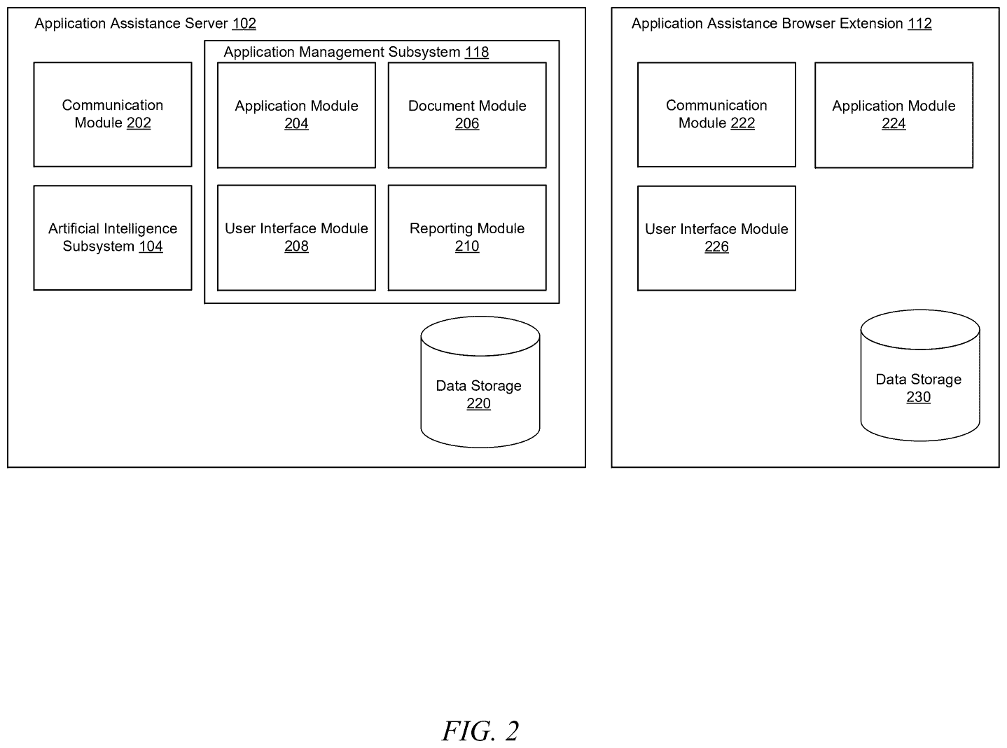

FIG. 2 depicts a block diagram of the application assistance server 102 and the application assistance browser extension 112 in some embodiments. In addition to the artificial intelligence subsystem 104 and the application management subsystem 118, the application assistance server 102 may include a communication module 202, an application module 204, a document module 206, a user interface module 208, a reporting module 210, and a data storage 220. The application module 204, the document module 206, the user interface module 208, and the reporting module 210 may be included in the application management subsystem 118 as depicted in FIG. 2. The application assistance browser extension 112 may include a communication module 222, an application module 224, a user interface module 226, and a data storage 230.

The communication module 202 of the application assistance server 102 may send requests or data between the application assistance server 102 and any of the application organization systems 106, the user systems 108, and the artificial intelligence model system 114. The communication module 202 may also receive requests or data from any of the application organization systems 106, the user systems 108, and the artificial intelligence model system 114. The communication module 222 of the application assistance browser extension 112 may send requests or data between the application assistance browser extension 112 and any of the application assistance server 102, the application organization systems 106, and the artificial intelligence model system 114.

The application module 224 of the application assistance browser extension 112 may obtain applications from an application at an application website. For example, the applications may be or be in one or more Hypertext Markup Language (HTML) documents. The application module 224 may also obtain applications from other types of documents, such as Portable Document Format (PDF) documents. The application module 204 of the application assistance server 102 may generate another application that includes the application questions. The application module 204 may also provide answers to the application questions that were generated by the artificial intelligence model system 114 in the other application and provide received modifications to the answers in the other application. The application module 204 of the application assistance server 102 may provide the answers to the application module 224 of the application assistance browser extension 112, which may automatically provide answers to the application questions in the application at the application website.

The user interface module 226 of the application assistance browser extension 112 may receive requests to obtain application questions in the application at the application website. The user interface module 208 of the application assistance server 102 may receive requests to have the artificial intelligence model system 114 generate answers to the application questions in the other application. The user interface module 226 of the application assistance browser extension 112 may receive requests to provide answers to the application questions in the application at the application website.

The data storage 220 may include data stored, accessed, or modified by any of the modules or subsystems of the application assistance server 102, and the data storage 230 may include data stored, accessed, or modified by any of the modules of the application assistance browser extension 112. The data storage 220 or the data storage 230 may include any number of data storage structures such as tables, databases, lists, or the like. The data storage 220 or the data storage 230 may include data that is stored in memory (for example, random access memory (RAM)), on disk or on solid-state devices, or some combination of in-memory and on-disk or on solid-state devices.

The document module 206 may receive documents that include information that is usable (for example, by the artificial intelligence model system 114) to generate answers to application questions. The document module 206 may also organize the documents into various categories or groups based on requests from users. The document module 206 may also provide the documents to the artificial intelligence model system 114 for use in generating answers to application questions.

The reporting module 210 may generate and provide reports that include information on applications. The reporting module 210 may provide reports, alerts, or dashboards that include application statuses and other information, such as expected funding amounts, total numbers of applications, or other information.

A module or subsystem of the application assistance server 102 or of the application assistance browser extension 112 may be hardware, software, firmware, or any combination. For example, each module or subsystem may include functions performed by dedicated hardware (for example, an Application-Specific Integrated Circuit (ASIC), a Field Programmable Gate Array (FPGA), or the like), software, instructions maintained in random access memory (RAM) or read-only memory (ROM), or any combination. Software may be executed by one or more processors. Although a limited number of modules or subsystems are depicted in FIG. 2, there may be any number of modules or subsystems. Further, individual modules or subsystems may perform any number of functions, including functions of multiple modules or subsystems as described herein. Moreover, although certain modules may be depicted as included in certain subsystems (for example, the application module 204 is depicted as included in the application management subsystem 118), such modules may be included (either completely or partially) in other subsystems or may be standalone modules within the application assistance server 102 or within the application assistance browser extension 112. Accordingly, the application assistance server 102 and the application assistance browser extension 112 are not limited to the configurations depicted in FIG. 2.

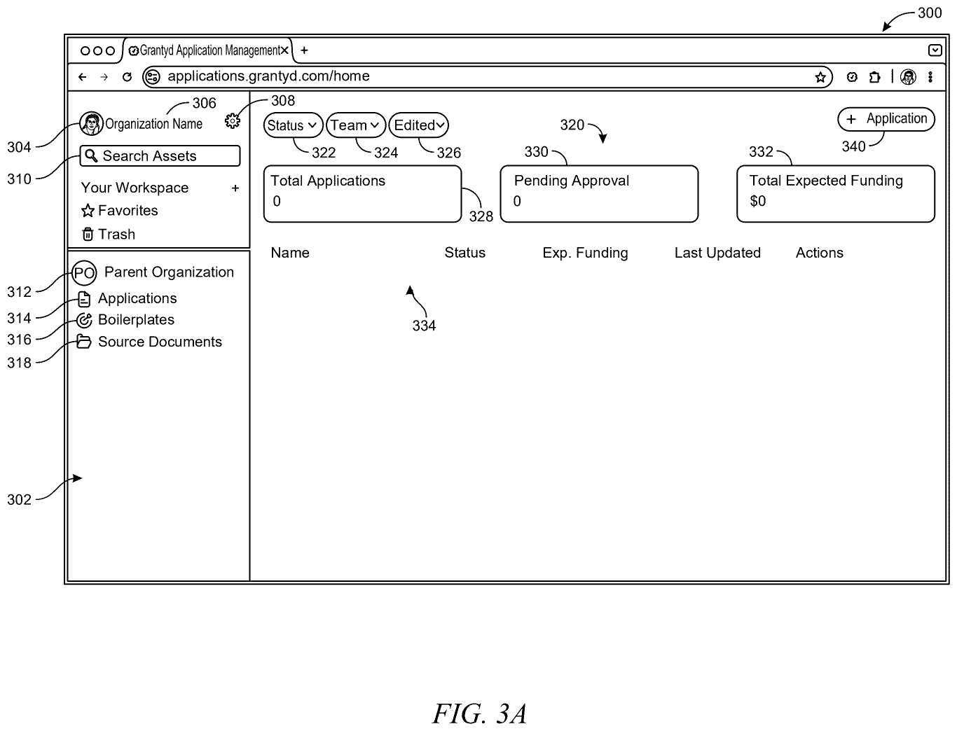

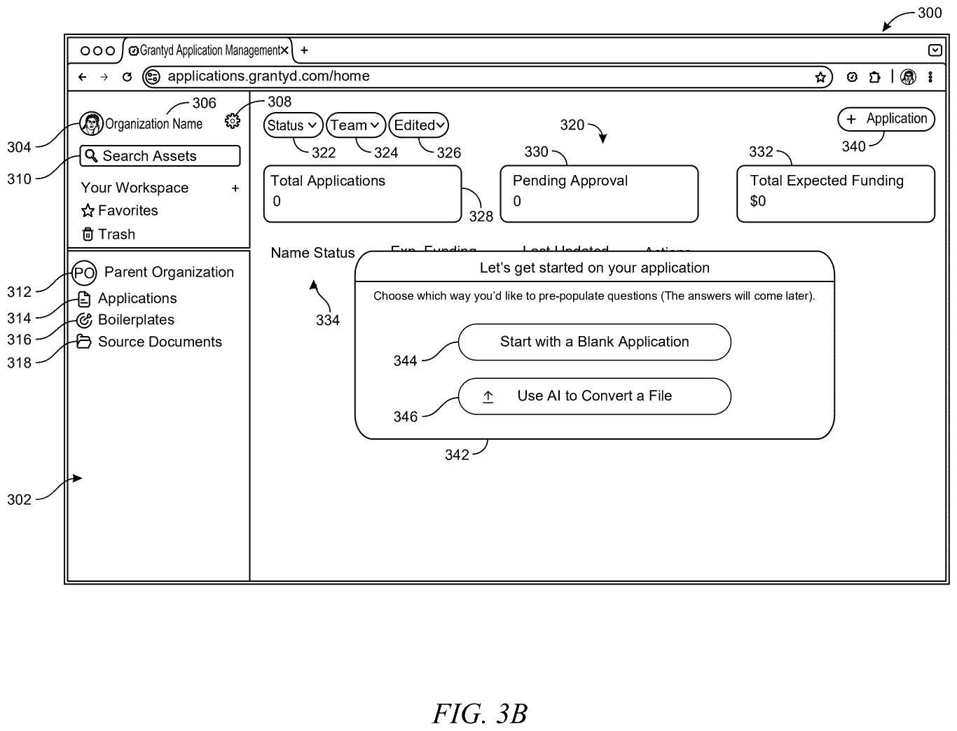

Some embodiments of the application assistance system are generally directed toward assisting individuals, such as employees of or consultants for non-profit or other organizations that may rely on grant funding, fill out or complete grant applications. FIGS. 3A-7D are described with respect to these particular embodiments. It is to be understood that these particular embodiments are exemplary, and the application assistance system is not necessarily limited to these particular embodiments.

FIG. 3A depicts a user interface 300 that the application assistance server 102 (for example, the user interface module 208) may provide in some embodiments. The user interface 300, which may be referred to herein as a dashboard, may include a first section 302 and a second section 320. The first section 302 may include a user profile icon 304 for a user and an organization name 306 of the organization that the user is an employee of or is otherwise associated with, such as through a consulting, contracting, or agency arrangement. The first section 302 may also include a settings icon 308 for managing settings of the organization name 306, a search field 310 for searching for grant applications or documents and a parent organization 312 name and icon. The parent organization 312 of the user may be different from the organization that the user is an employee of or is otherwise associated with. The first section 302 may also include a link 314 named “Applications” for functionality associated with grant applications, a link 318 named “Source Documents” for functionality associated with documents that may be used to for answer grant application questions, and a link 316 named “Boilerplates” for additional functionality associated with such documents.

The second section 320 may include a grant application section 334 that may display grant applications, such as grant applications that are in progress or have been submitted. The second section 320 may also include buttons for filtering grant applications, such as a status button 322 for filtering grant applications by status, a team button 324 for filtering grant applications by teams that are associated with the grant applications, and an edited button 326 for filtering grant applications by grant applications that may or may not have been edited by users. The second section 320 may also include a total applications region 328 that may display a total number of grant applications, a pending approval region 330 that may display a number of grant applications that are pending approval, and a total expected funding region 332 that may display a total amount of funding expected for grant applications, such as grant applications that are pending approval or have been submitted.

The second section 320 may also include an add grant application button 340 labeled “+Application.” When a user selects the add grant application button 340, the user interface module 208 may receive the selection and display an overlay 342, as depicted in FIG. 3B. The overlay 342 may provide two options for starting a grant application: a first option 344 that when selected by the user may allow the user to start with a blank grant application for which the user may specify questions and provide answers, and a second option 346 that when selected by the user may allow the user to request that the application assistance server 102 access a document or file and determine the grant application questions in the document or file. For example, the user may use the second option to have the application assistance server 102 access a Portable Document Format (PDF) document (such as a PDF file with fillable fields) and determine, based on the structure of the PDF file, what the grant application questions in the PDF document are. Other examples of documents or files that the application assistance server 102 may utilize to determine grant applications are Microsoft Word document format documents, Extensible Markup Language (XML) document format documents, and other document file format documents.

Although the application management subsystem 118 may provide these two options for starting a grant application, a typical use of the application assistance system may involve the user utilizing the application assistance browser extension 112 to obtain application questions in a grant application at a grant application website and to generate another grant application that includes the application questions a proposal into the application management subsystem 118. In such a case, the grant application may be or be included in a grant application document that is or includes one or more HTML documents that are provided by the grant application website.

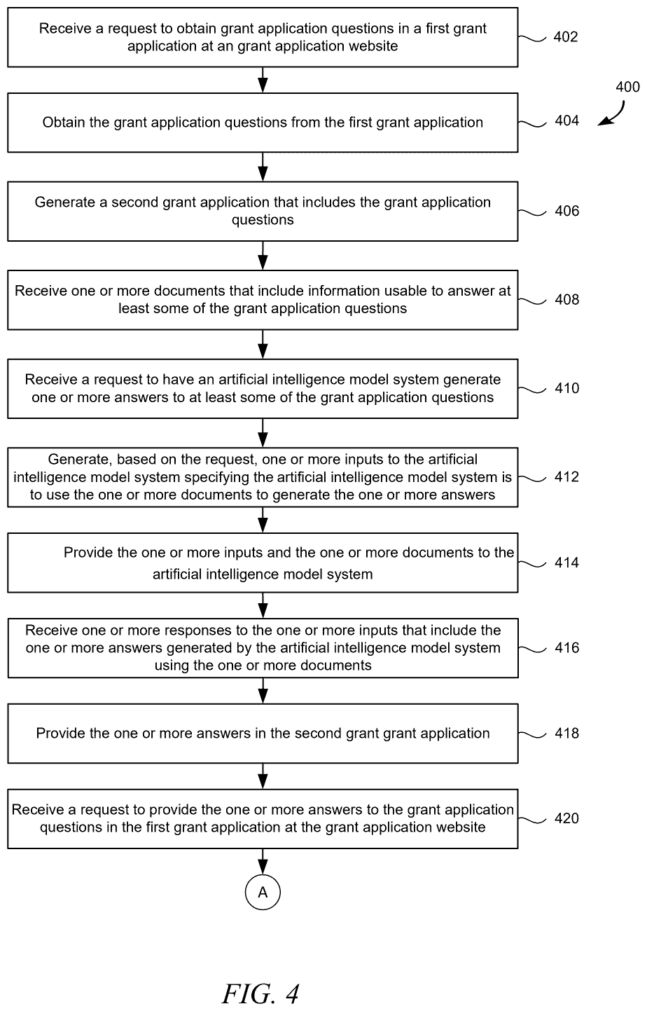

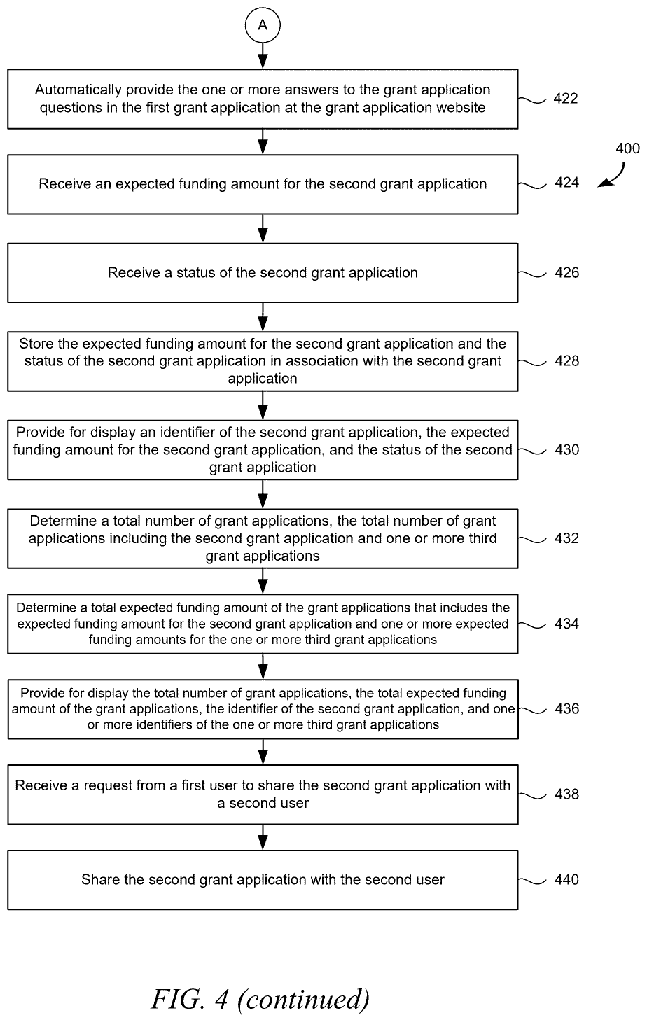

FIG. 4 depicts a method 400 for generating answers to application questions in some embodiments. The method 400 is described in the context of the example environment 100 of FIG. 1. The application assistance system (for example, various modules or subsystems of the application assistance server 102 or the application assistance browser extension 112) may perform the method 400. The method 400 may begin at step 402 where the application assistance browser extension 112 (for example, the user interface module 226) may receive a request to obtain grant application questions in a first grant application at a grant application website, such as from a user of the application assistance system.

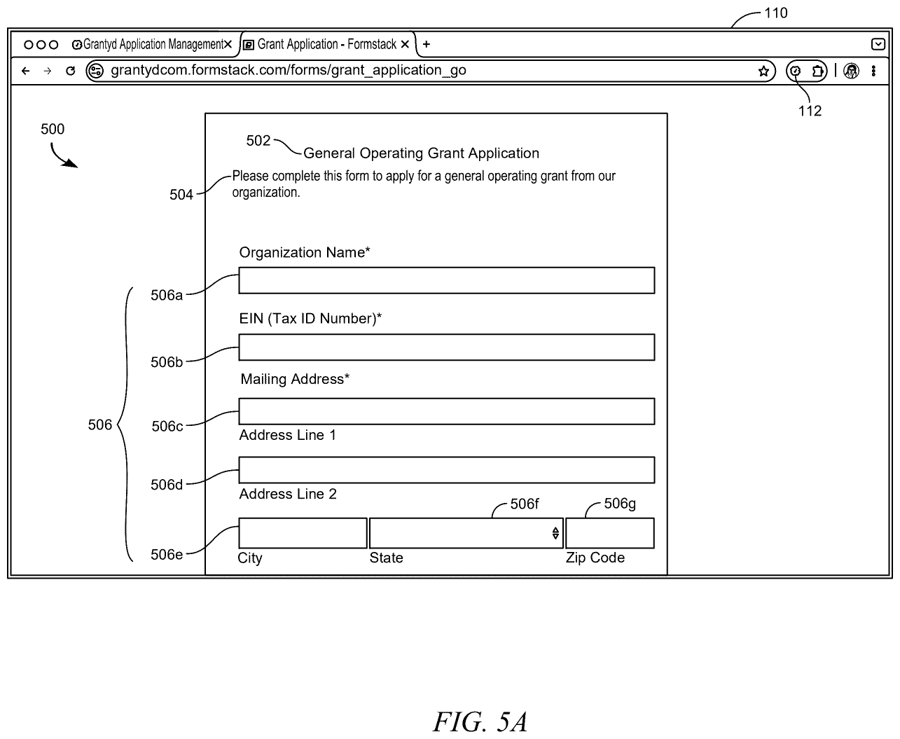

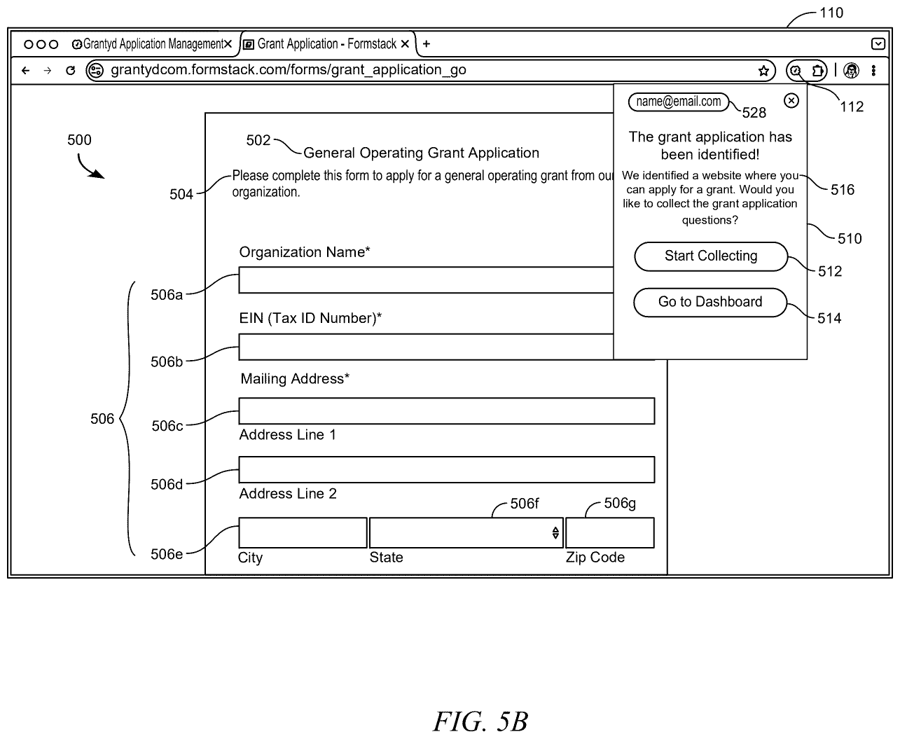

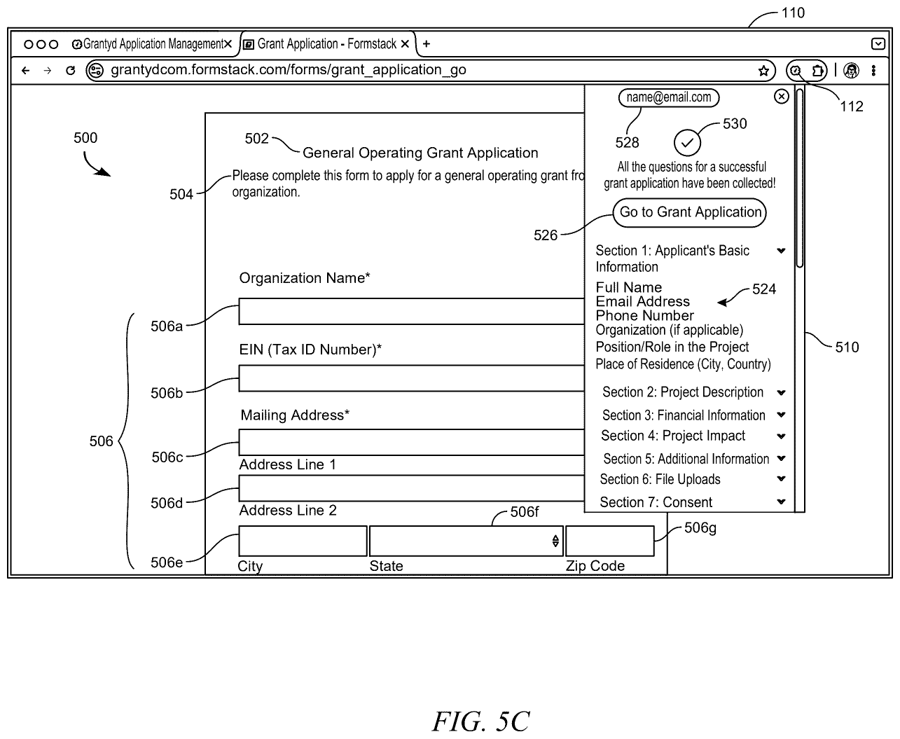

FIG. 5A depicts an example grant application 500 at a grant application website that may be provided by an application organization system 106, as displayed by the browser 110. The grant application 500 may include a name 502 and instructions 504 of the grant application. The grant application 500 may also include grant application questions 506 (shown individually as grant application question 506a, grant application question 506b, grant application question 506c, grant application question 506d, grant application question 506e, grant application question 506f, and grant application question 506g). Certain grant application questions, such as those with an asterisk in the grant application name or label (for example, grant application question 506a for “Organization Name*”) may be required by the grant application 500 in order for the grant application 500 to be successfully submitted.

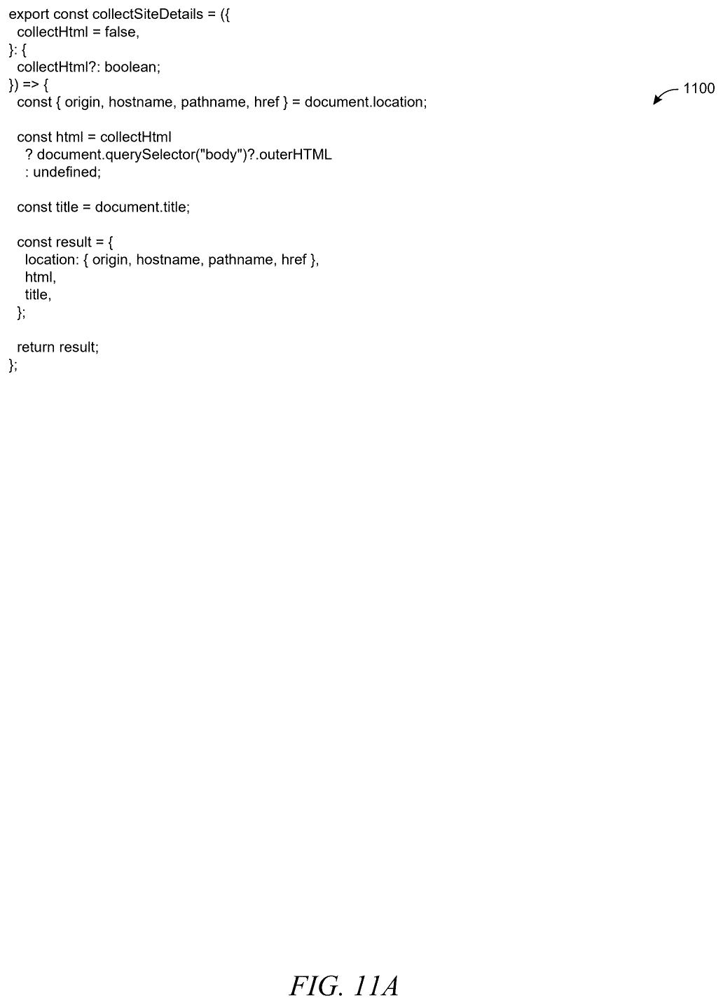

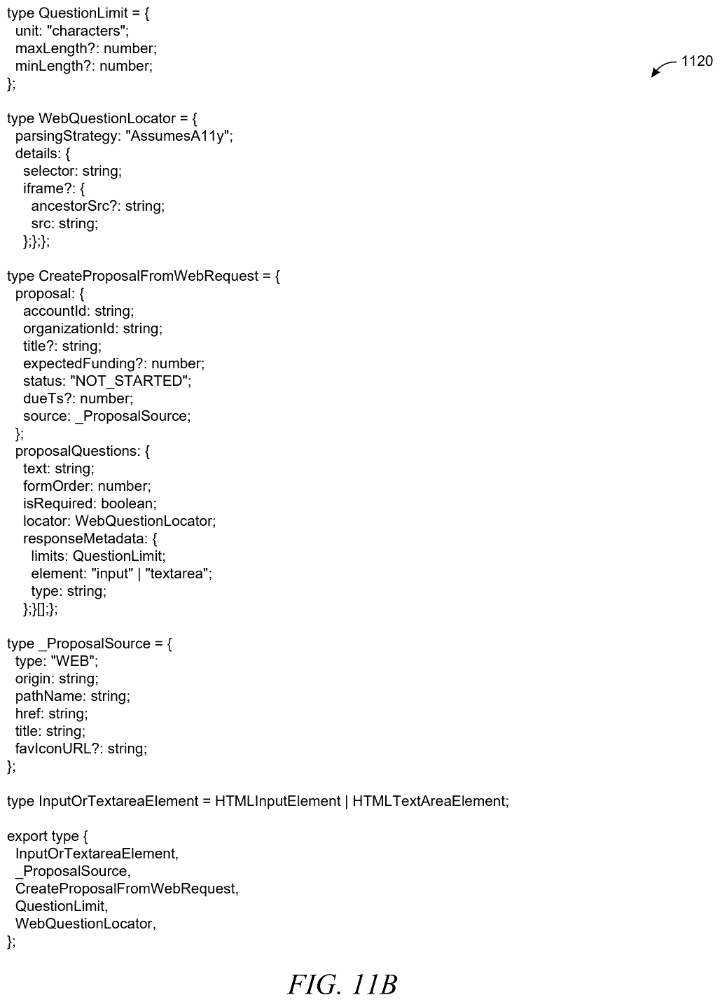

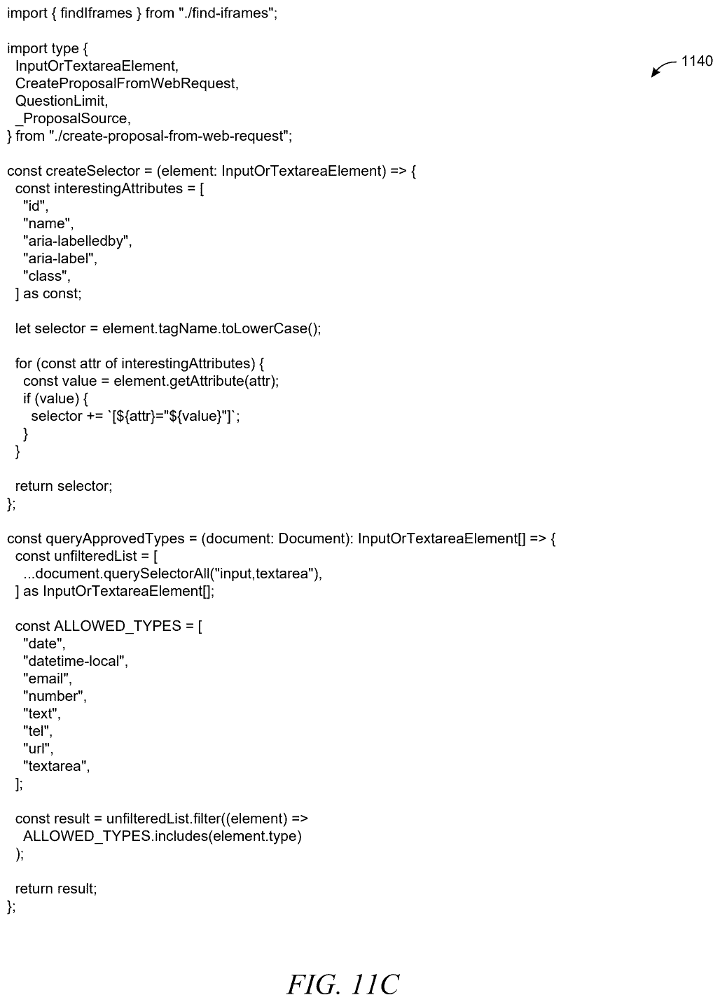

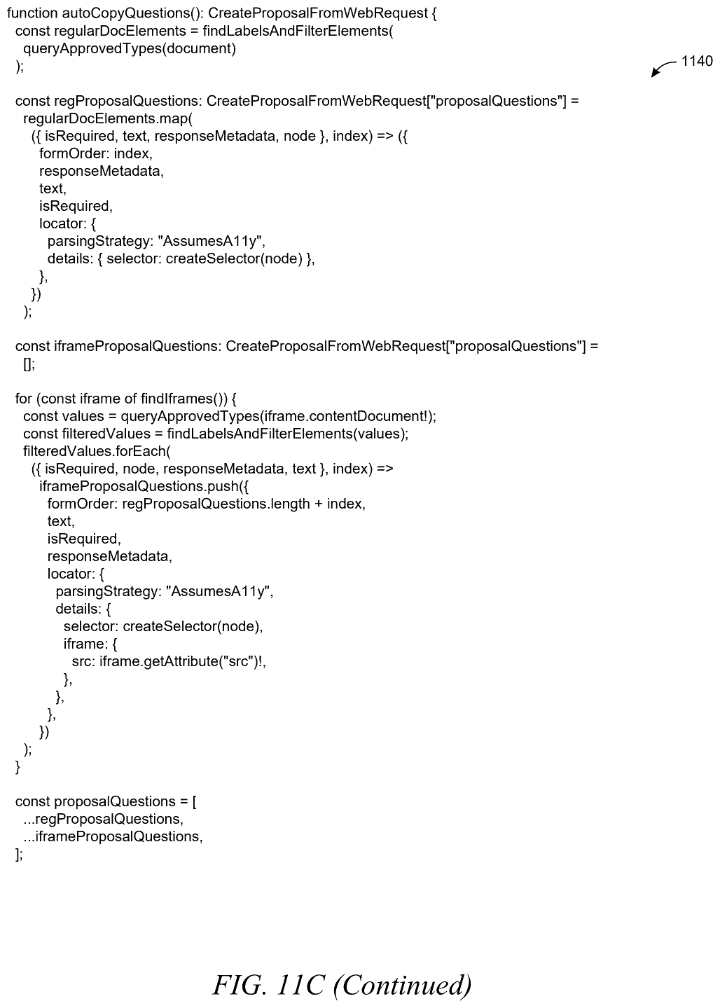

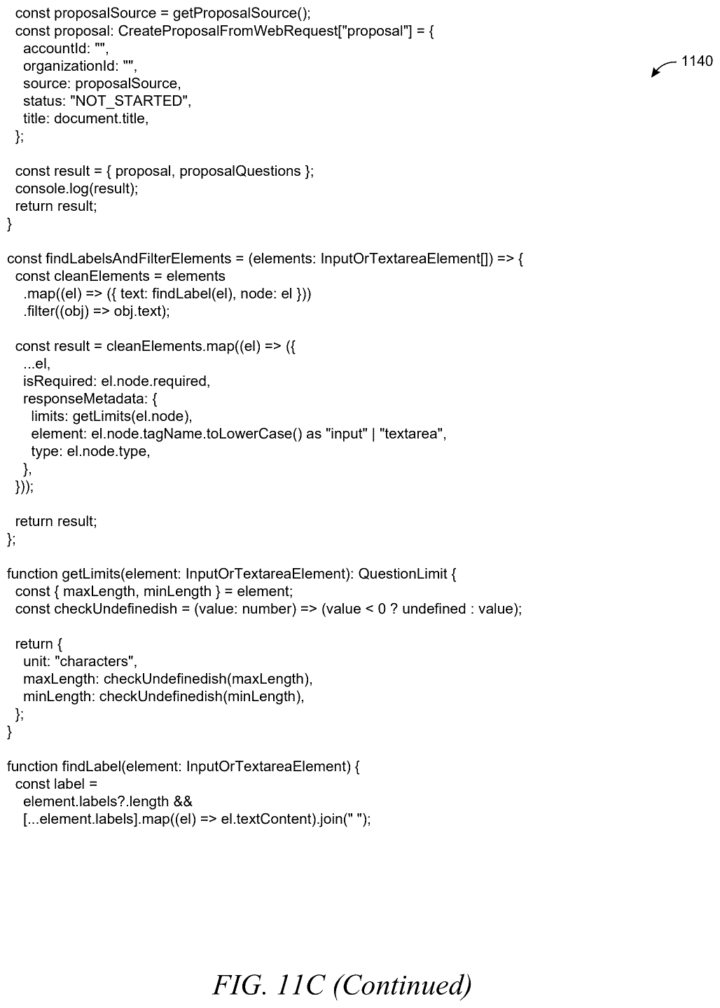

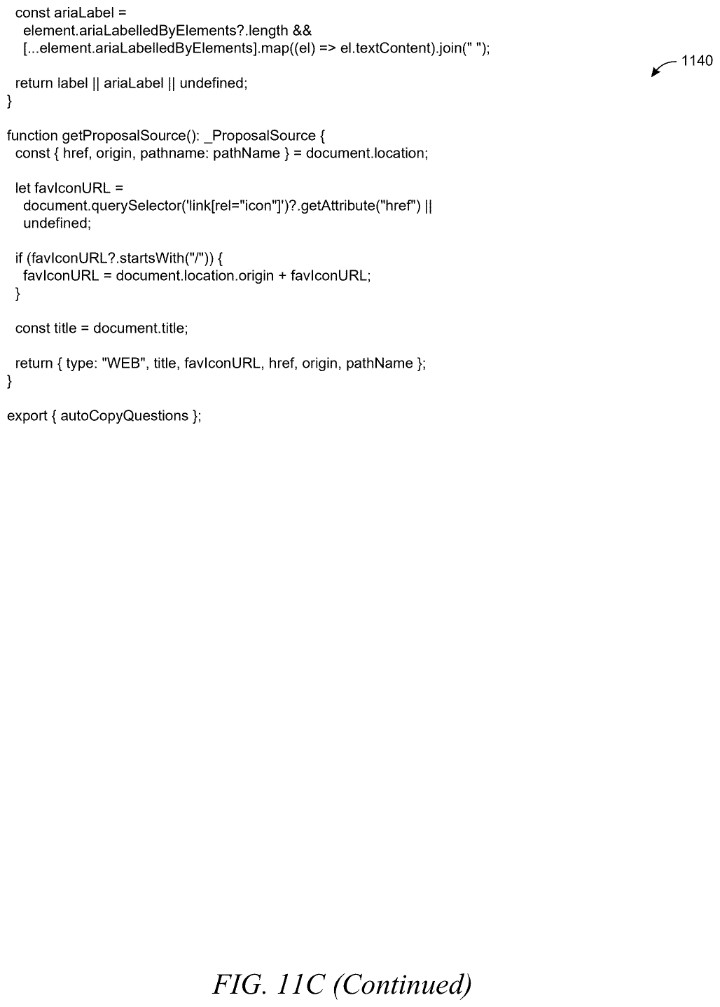

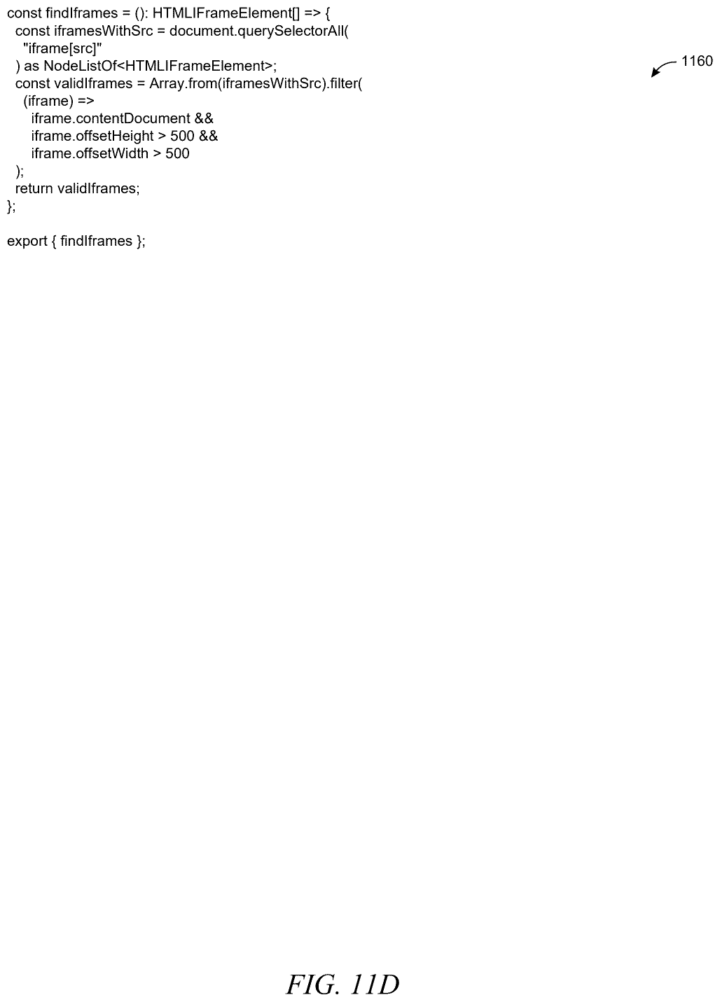

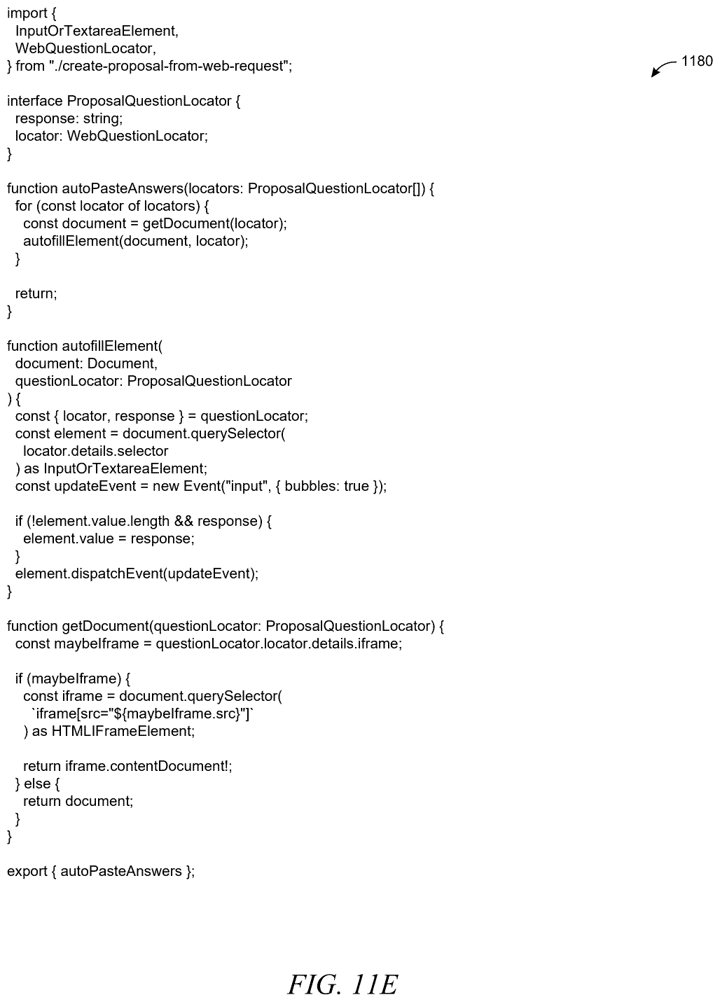

The browser 110 includes the application assistance browser extension 112, which is located in the browser extension section of the browser 110. If the user selects the application assistance browser extension 112, the application assistance browser extension 112 causes an overlay 510 to be displayed by the browser 110, as depicted in FIG. 5B. The overlay 510 includes an indicator 528 of the user of the application assistance system, a button 512 labeled “Start Collecting,” and a button 514 labeled “Go to Dashboard.” The application assistance browser extension 112 may obtain information about the grant application web page or the grant application, such as the grant application website host name, the URL of the grant application web page or website, and the web page title. FIG. 11A depicts example software code 1100 that the application assistance browser extension 112 of the application assistance system may utilize to obtain information about the grant application web page or the grant application.

Returning to FIG. 5B, the overlay 510 also includes text 516 indicating that the application assistance browser extension 112 has identified the grant application website (or web page) as a website (or a web page) where the user may apply for a grant. In various embodiments, the application assistance browser extension 112 identifies grant application websites (or web pages) using the website uniform Resource Locator (URL), text on the web page (for example, the name 502 of the grant application), or one or more HTML Document Object Models (DOMs) of the web page(s). For example, the application assistance browser extension 112 may utilize the one or more DOMs to detect the HTML form element. The application assistance browser extension 112 may also utilize the one or more DOMs to detect form elements of the HTML form element, such as input elements, textarea elements, or button elements, to detect the grant application questions 506. The application assistance browser extension 112 may also utilize some combination of the foregoing. In some embodiments, the application assistance browser extension 112 may activate the button 512 so that the button 512 is selectable by the user only after identifying a grant application website.

The user may cause the browser 110 to navigate to the user interface 300 of FIG. 3A by selecting the button 514. To request that the application assistance browser extension 112 obtain the grant application questions 506, the user may select the button 512. Returning to FIG. 4, at step 404, the application assistance browser extension 112 may obtain the grant application questions 506 from the grant application 500. For example, the application assistance browser extension 112 may utilize of the grant application website (or web page) to identify form fields. For example, the application assistance browser extension 112 may utilize the one or more DOMs to identify such form fields that accept text input, such as input elements of type text, date, datetime-local, email, number, tel, or url, and text area elements. The application assistance browser extension 112 may utilize the one or more DOMs to filter out form elements of types other than form elements that accept text input and text area elements, and only obtain information about form elements that accept text input and text area elements. In some embodiments, the application assistance browser extension 112 may utilize the one or more DOMs to obtain information about form elements in addition to form elements that accept text input and text area elements. For example, the application assistance browser extension 112 may detect form fields such as radio buttons and drop-down lists.

For form elements, the application assistance browser extension 112 may obtain the form field type, the form field identifier, the form field class, the label associated with the form field, the location of the form field in the form (for example, where the form field is in the order) and any other form field information, such as character limits (or word limits) and whether the form field requires input for the grant application 500 to be successfully submitted. The application assistance browser extension 112 may also detect accessibility information associated with form fields, such as “aria-label” information. FIG. 11B depicts example software code 1120 and FIG. 11C depicts example software code 1140 that the application assistance browser extension 112 of the application assistance system may utilize to obtain the grant application questions 506.

Certain grant application web pages or grant application websites may pose technical problems to the collection of application questions by the application assistance browser extension 112. One technical problem relates to identifying all the grant application questions at a grant application website that provides (or appears to provide) all the grant application questions in more than one web page (which may be referred to as a multi-page form). One technical solution to this technical problem may involve the application assistance browser extension 112 utilizing the one or more DOMs to obtain all of the grant application questions, even if the grant application questions span (or appear to span) more than one web page. In such cases, only a subset of the grant application questions may be visible to the user on a web page, with the remainder of the application questions being part of the software code of the web page but hidden from the user. By utilizing the one or more DOMs, the application assistance browser extension 112 may detect and obtain grant application questions that are visible and grant application questions that are hidden. The application assistance browser extension 112 may detect properties or attributes of form elements or associated elements using the DOM to determine if the grant application questions are visible or hidden. The application assistance browser extension 112 may store an association of grant application questions with the web page that the grant application questions are visible on (for example, in the data storage 230) and provide the stored data to the application assistance server 102.

Another technical problem relates to identifying the portions of a grant application web page or pages that may include grant application questions. Grant application web pages may include website elements, such as iframe elements, that may include grant application questions. Various iframe elements may be from different sources (for example, different websites) and may have different sizes or visibilities. However, other iframe elements from different sources may be from other sources and display content other than grant application questions. One technical solution to identifying portions of the grant application website that may include application questions may involve the application assistance browser extension 112 generating a data structure that includes all the iframe elements and filtering out iframe elements that are unlikely to include grant application questions.

FIG. 11D depicts example software code 1160 that the application assistance browser extension 112 of the application assistance system may utilize to find all the iframes in a web page at an application website. The application assistance browser extension 112 may utilize the software code 1160 to generate a data structure that includes all the iframes. The application assistance browser extension 112 may iterate through the data structure to identify the iframes that meet certain criteria that indicate that the iframes are likely to include grant application questions, and remove iframes that do not meet such criteria, thereby obtaining a filtered data structure. Such criteria may relate to the size of the iframe, on an assumption that only iframes larger than a certain size may include application questions. For example, the application assistance browser extension 112 may include only the iframes where both the viewable height of the iframe (in pixels) and the viewable height of the iframe (in pixels) is greater than or equal to one particular value (for example, 500 pixels) or two particular values (one particular value for the height, and one particular value for the width).

The application assistance browser extension 112 may utilize other criteria, such as where the area of the iframe (as determined by the viewable height and the viewable width of the iframe) is greater than or equal to a particular value, or where the percentage of the area of the iframe (as determined by the viewable height and the viewable width of the iframe) over the area of the web page (as determined by the viewable height and the viewable width of the web page) exceed a certain percentage. Additionally or alternatively, the application assistance browser extension 112 may utilize other criteria, such as the position of the iframe on the web page, to identify the iframe elements that are likely to include grant application questions. The application assistance browser extension 112 may remove iframes that do not meet the one or more criteria from the data structure, thereby obtaining a filtered data structure.

Additionally or alternatively, the application assistance browser extension 112 may generate a first data structure for iframes, iterate through the first data structure to identify iframes that meet the one or more criteria, and generate a second data structure that includes only the identified iframes. Additionally or alternatively, the application assistance browser extension 112 may iterate through the iframes and add only those iframes that meet one or more criteria to a data structure. Other variations are possible.

As a web page may include numerous iframes that do not include application questions (for example, iframes that include advertisements, scripts or other web page elements that may not be visible to users), the use of a filtered list of iframes may save significant computing resources, such as processing or memory resources, as the application assistance browser extension 112 does not need to iterate through such iframes. Accordingly, the techniques of the application assistance browser extension 112 may provide significant improvements to computing technology.

After identifying the iframe elements that are likely to include grant application questions, the application assistance browser extension 112 may utilize the DOM for each iframe to determine if the iframe includes grant application questions. The application assistance browser extension 112 may use the techniques described herein to determine if the iframe includes grant application questions (for example, utilize the DOM of the iframe to detect the HTML form element or form elements of the HTML form element, such as input elements, textarea elements, or button elements, to determine if the iframe includes any grant application questions).

After obtaining the grant application questions 506, the application assistance browser extension 112 may provide the grant application questions 506 or other information about the grant application 500 to the application assistance server 102. For example, the application assistance browser extension 112 may provide the form field type, the form field identifier, the form field class, the label associated with the form field, the location of the form field in the form (for example, where the form field is in the order) and any other form field information, such as character limits (or word limits) and whether the form field requires input for each grant application question to the application assistance server 102. The application assistance server 102 may store such information, for example, in the data storage 220.

At step 406 of FIG. 4, the application assistance server 102 may generate another grant application that includes the grant application questions 506. The other grant application may be a copy or duplicate of the grant application 500, and have the name 502, the instructions 504, and the grant application questions 506 of the grant application 500, as well as other information such as character or word limits for the grant application questions 506.

After obtaining the grant application questions 506, the application assistance browser extension 112 may update the overlay 510 to display a checkmark 530 and associated text indicating that the application assistance browser extension 112 has successfully obtained the grant application questions from the grant application 500, as depicted in FIG. 5C. The application assistance browser extension 112 may display the grant application questions 506 as application questions 524 in the overlay 510. In some embodiments, the application assistance browser extension 112 displays the application questions 524 according to an organization (for example, by sections) of the grant application 500. The application assistance browser extension 112 may also cause the overlay 510 to include another button 526 in the overlay 510, labeled “Go to Grant Application.”

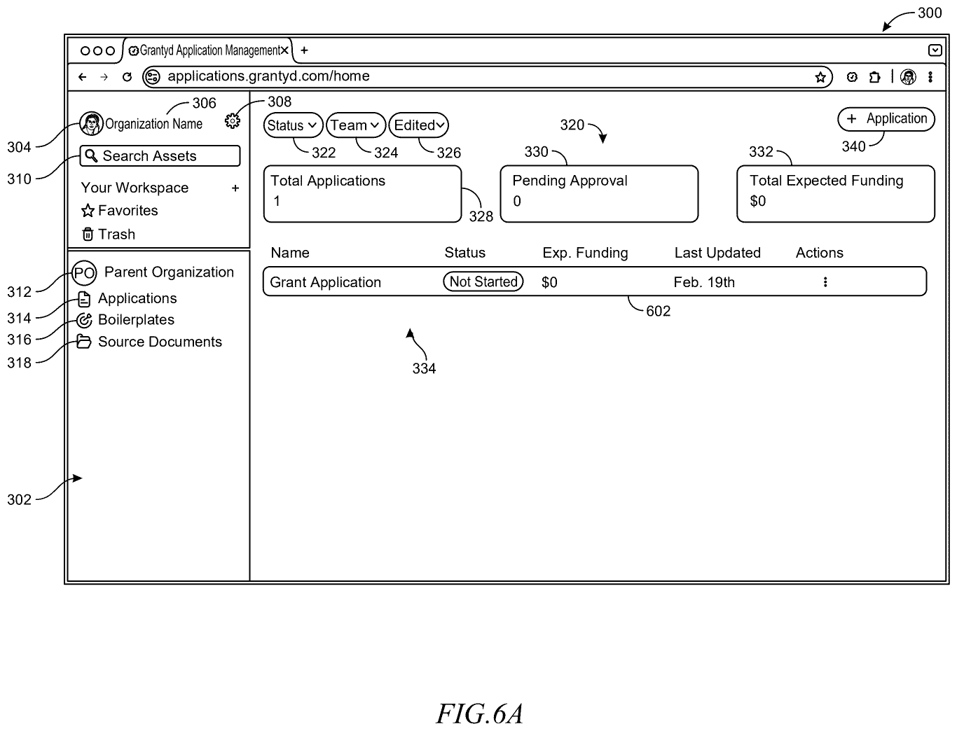

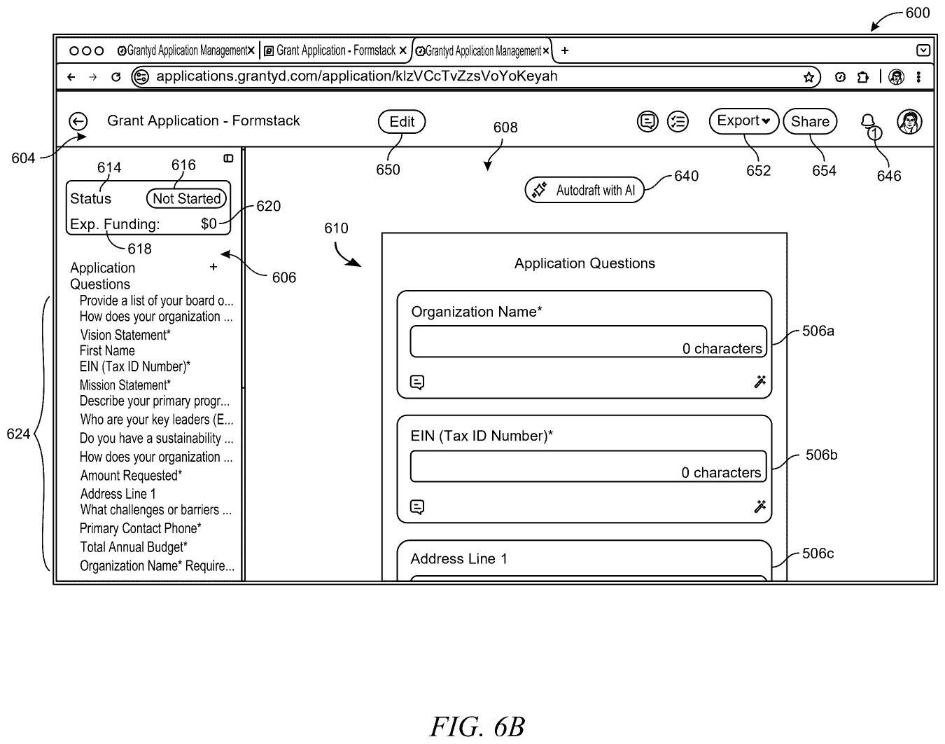

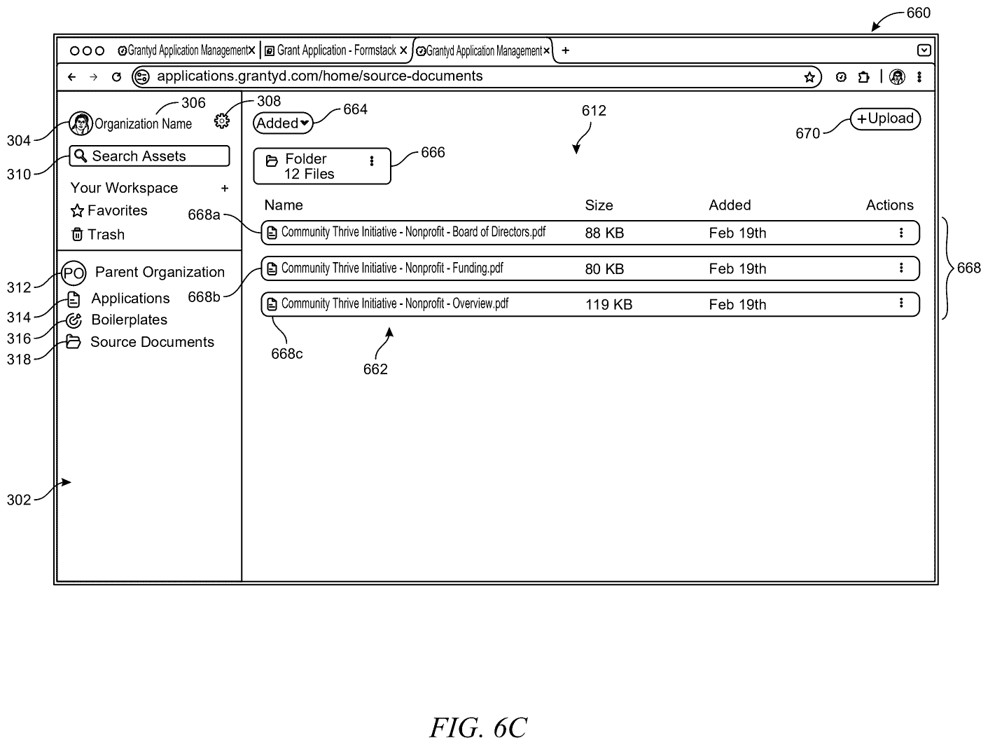

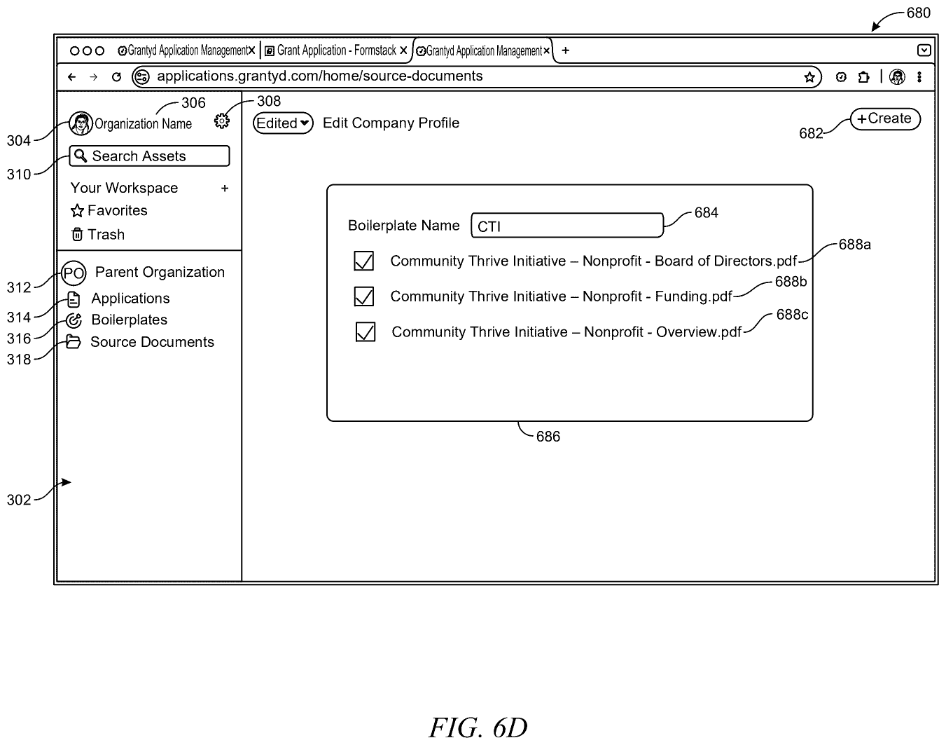

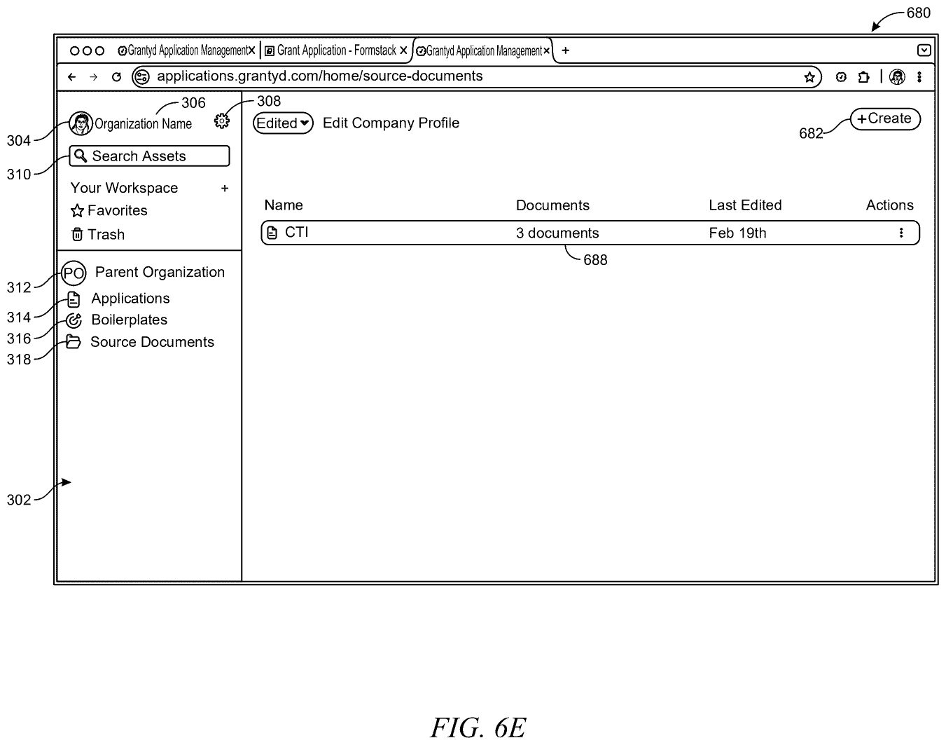

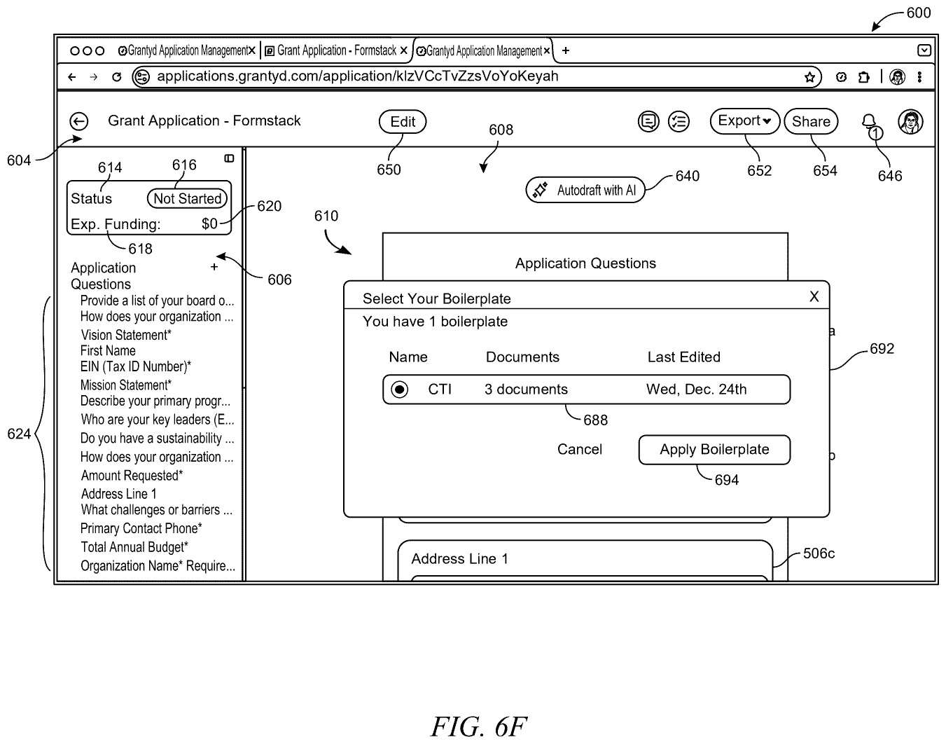

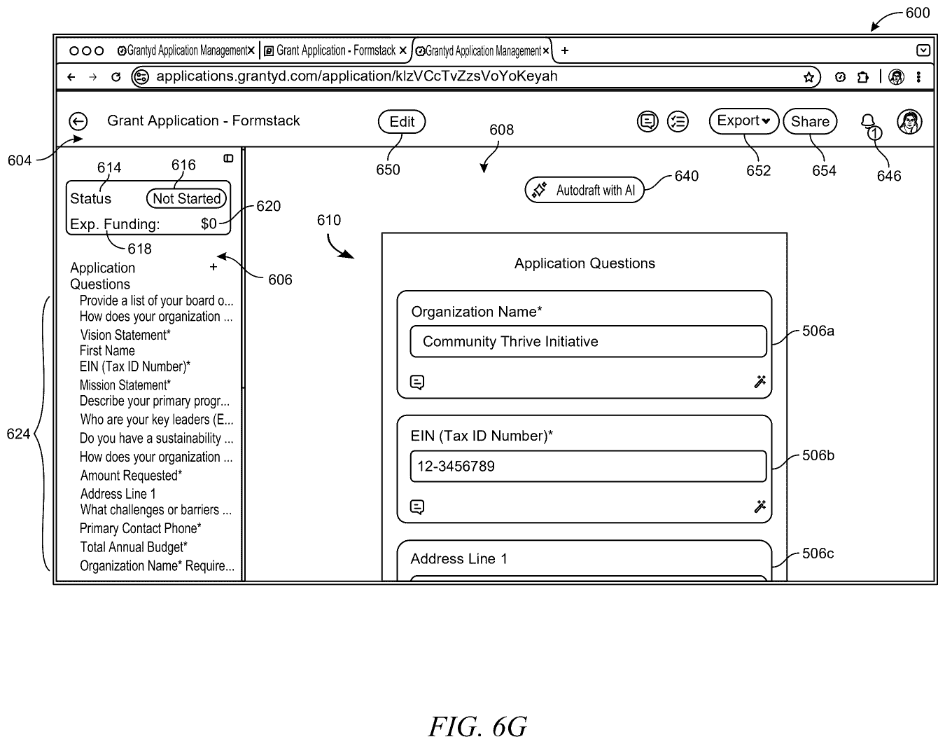

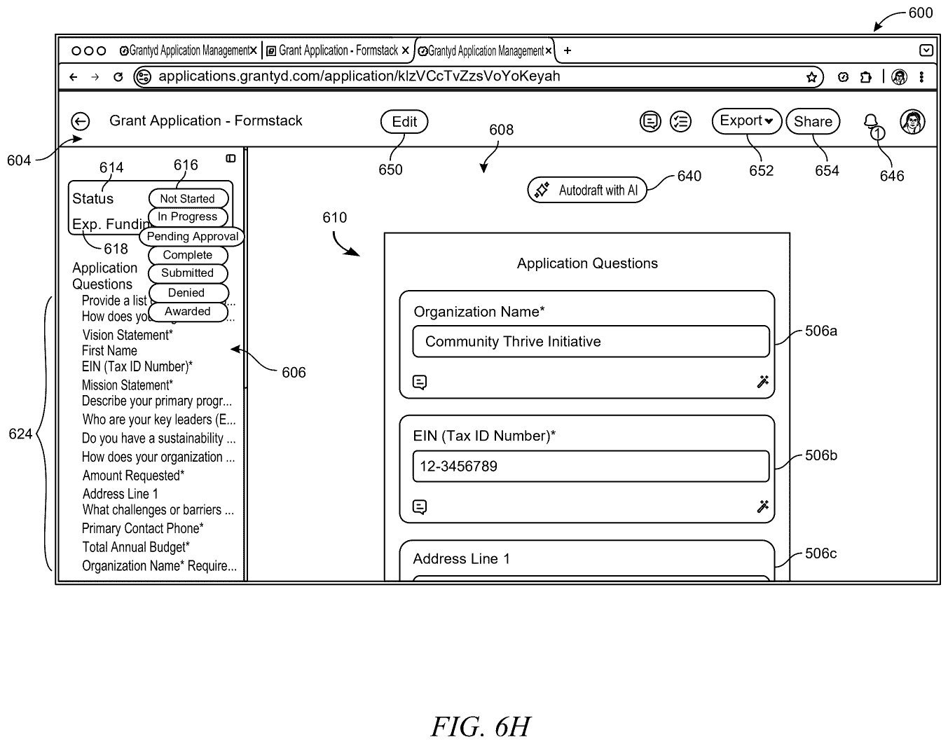

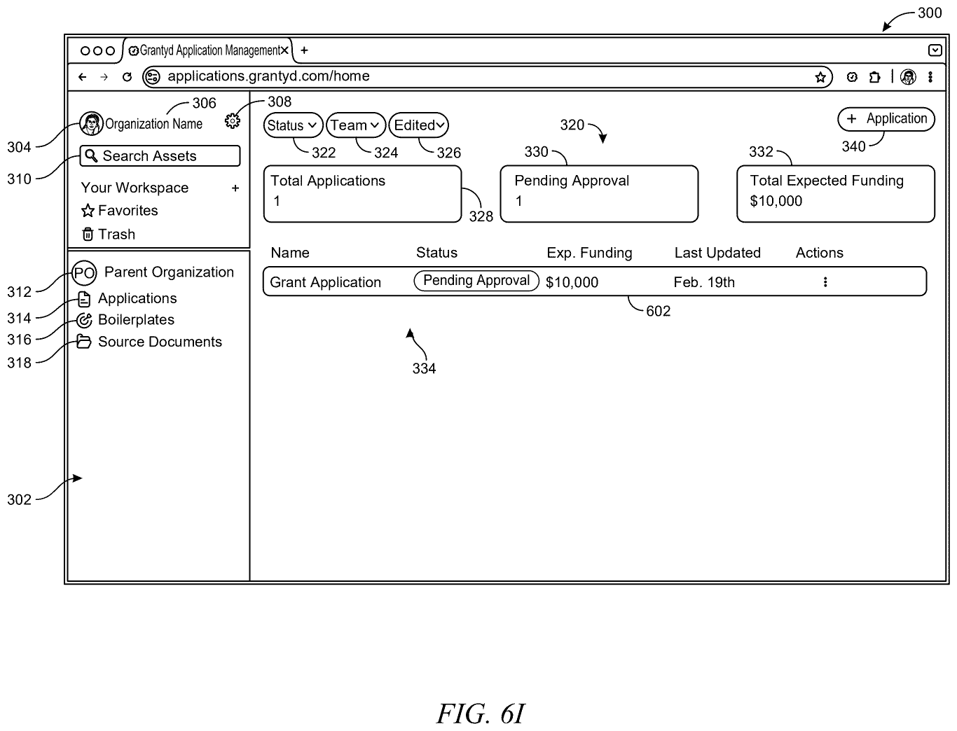

If the user selects the button 526, the application assistance browser extension 112 may cause the browser 110 to navigate to the user interface 300. FIG. 6A depicts the user interface 300 after the application assistance server 102 has received the grant application questions 506 from the application assistance browser extension 112 and generated another grant application that includes the grant application questions 506. FIG. 6A depicts that the application assistance server 102 (for example, the application module 204) may have updated a grant applications data structure (stored, for example, in the data storage 220) so that the grant application section 334 now includes a listing 602 of the generated grant application. The listing 602 may also include other details about the generated grant application, such as the status, the expected funding, and the date the generated grant application was last updated. The application assistance server 102 (for example, the application module 204) may have also updated a total applications count so that the total applications region 328 displays an updated total number of grant applications. In some embodiments, the application assistance server 102 also includes a deadline for the generated grant application and provides notifications to the user about deadlines, thereby assisting the user with completing the grant application before the deadline.

If the user selects the generated grant application in the listing 602, the application assistance server 102 (for example, the user interface module 208) may provide a user interface 600 as depicted in FIG. 6B for display. The user interface 600 may include a first section 608, a second section 606, and a third section 604. The first section 608 may include a grant application 610 that the application assistance server 102 generated. The grant application 610 may include the grant application questions 506. The user may provide answers to the grant application questions 506 by manually typing answers to each grant application question using the user interface 600. However, the first section 608 may also include a button 640 labeled “Autodraft with AI.” As discussed in more detail herein, the user may select the button 640 to request that the artificial intelligence model system 114 generate answers to the grant application questions 506.

The second section 606 may include a listing 624 of the grant application questions. A grant application question in the listing 624 may be hyperlinked to a grant application question 506 in the grant application 610 to allow the user to navigate to the grant application question 506. The second section 606 may also include a status 614 of the grant application 610, which the user may set by selecting a button 616, which is currently showing a status of “Not Started” for the grant application 610. The second section 606 may also include an expected funding amount 618 of the grant application 610, which the user may set by modifying a value 620.

The third section 604 may also include buttons for various functionality, such as a button 650 labeled “Edit” for editing the grant application 610, a button 652 labeled “Export” for exporting the grant application 610 (for example, to a PDF or Word document file), a button 654 labeled “Share” for sharing the grant application 610 (for example, with another user of the application assistance system), and a notification icon 646 for informing the user of system messages or notifications.

The application assistance system may allow users to request answers to grant application questions 506 to be generated by the artificial intelligence model system 114. To do so, the user may specify documents to be used by the artificial intelligence model system 114 to generate answers to the grant application questions 506. Returning to FIG. 4, at step 408 the application assistance server 102 (for example, the document module 206) may receive one or more documents that include information usable to answer the grant application questions 506.

FIG. 6C depicts an example user interface 660 that the application assistance server 102 (for example, the user interface module 208) may provide for display when, for example, the user may have selected the link 318 in the first section 302. The user interface 660 may include the first section 302 and a second section 612. The second section 612 may include a button 670 labeled “+Upload” that if selected by the user may cause the application assistance server 102 (for example, the document module 206) to allow the user to upload documents to the application assistance server 102 or another location. For example, the user may upload documents from the user system 108 or from other storage locations such as network storage. The application assistance server 102 (for example, the document module 206) may allow the user to organize documents into folders.

The second section 612 may also include a region 662 with listings 668 (shown individually as listing 668a, listing 668b, and listing 668c) of documents that the user has uploaded. Each listing 668 may include a name and a size of the document as well as a date the document was uploaded. The second section 612 may also include a region 666 indicating a folder organization of documents that are available to the application assistance system and a button 664 indicating that documents have been added to the application assistance system. Actions may be available for each listing 668, such as deleting documents or replacing documents.

For a grant application, documents that may be used to generate answers to the grant application questions may include proposals, budgets, mission statements, and reports. The application assistance server 102 (for example, the document module 206) may allow the user to organize the documents (for example, based on document type or purpose) and associate one or more documents with a project (for example, a project to obtain funding for a particular initiative of a non-profit organization) or to group one or more documents into a set or collection of documents. The user may also specify that only certain documents in the user's documents may be used to generate answers to grant application questions. This feature may be useful for users that utilize different versions of documents or different documents for the various grant applications that the user is working on.

FIG. 6D depicts an example user interface 680 that the application assistance server 102 (for example, the user interface module 208) may provide for display when, for example, the user may have selected the link 316 in the first section 302. The user may create a boilerplate to be used to generate answers to grant application questions by selecting the button 682 labeled “+Create,” which may cause the application assistance server 102 (for example, the user interface module 208) to provide for display an overlay 686. In the overlay 686, the user may specify a boilerplate name in input field 684 and specify one or more of document 688a, document 688b, and document 688c to be part of the boilerplate using the corresponding checkboxes. FIG. 6E depicts the user interface 680 showing a listing 688 for a boilerplate named “CTI” with three documents. The application assistance server 102 may allow the user to perform certain actions regarding the boilerplate, such as renaming the boilerplate or adding or removing documents from the boilerplate.

Returning to FIG. 4, at step 410 the application assistance server 102 (for example, the user interface module 208) may receive a request to have the artificial intelligence model system 114 generate answers to the grant application questions 506. For example, the user may select the button 640 labeled “Autodraft with AI,” as depicted in FIG. 6F, to provide the request. Upon selecting this button, the application assistance server 102 (for example, the user interface module 208) may provide for display an overlay 692. The overlay 692 may request that the user select or confirm a boilerplate containing one or more documents to be used by the artificial intelligence model system 114 to generate answers to the grant application questions 506. The overlay 692 displays only a single listing for a boilerplate, the listing 688, though there may be several listings displayed, one for each boilerplate. The user may select or confirm a boilerplate to be used and then select the button 694 labeled “Apply Boilerplate.” In some embodiments, the artificial intelligence model system 114 utilizes only the documents in the selected boilerplate in generating answers to the grant application questions.

Returning to FIG. 4, at step 412 the application assistance server 102 (for example, the artificial intelligence subsystem 104) may generate, based on the request to have the artificial intelligence model system generate answers to the grant application questions 506, one or more inputs to the artificial intelligence model system 114. The one or more inputs may specify that the artificial intelligence model system 114 is to use the documents associated with the selected boilerplate to generate the answers. The artificial intelligence subsystem 104 may generate the one or more inputs. The inputs may include prompts for the artificial intelligence model system 114 that are based on the grant application questions 506 or are related to or associated with the grant application questions 506.

An example prompt that the artificial intelligence subsystem 104 may generate to request that the artificial intelligence model system 114 generate an answer may be or include language similar to the following: “Using the [document(s) associated with the selected boilerplate], answer this grant application question [reference to grant application question and optional data, such as character or word limits].” The artificial intelligence subsystem 104 may generate such a prompt for each proposal question answer to be generated by the artificial intelligence model system 114. Additionally or alternatively, the artificial intelligence subsystem 104 may generate a prompt for two or more of the grant application questions 506. The artificial intelligence subsystem 104 may also generate an introductory prompt such as “You are a grant writing assistant. Given a list of questions, answer to the best of your ability to help the user successfully apply for a grant. You may make up a fake hypothetical non-profit to base your answers on. If character or word limits exist, try to approach but never exceed them.”

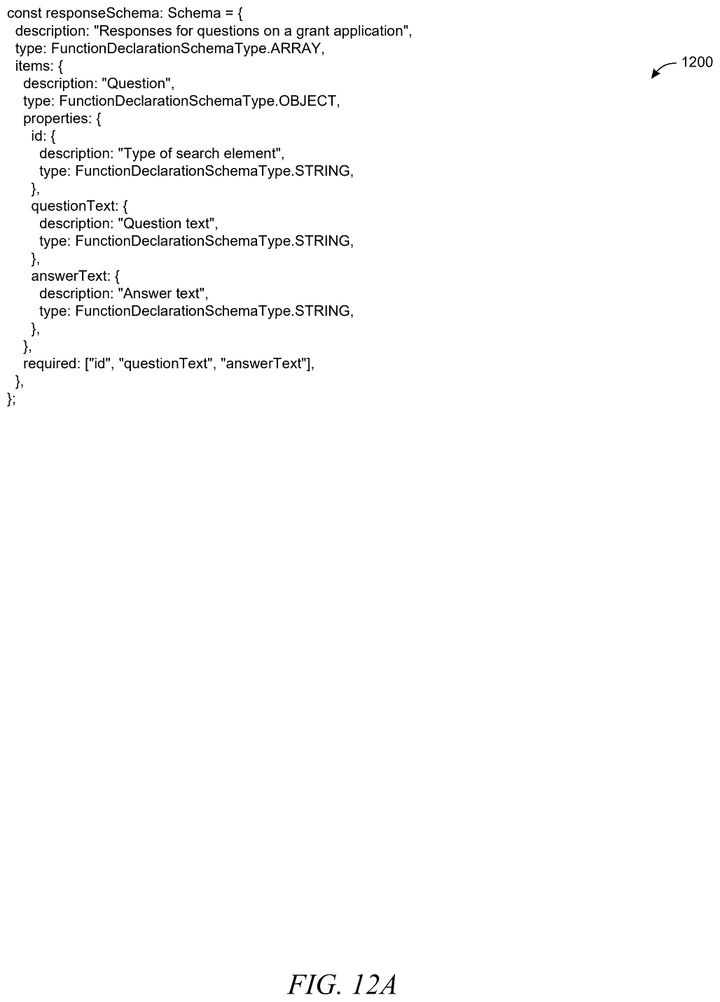

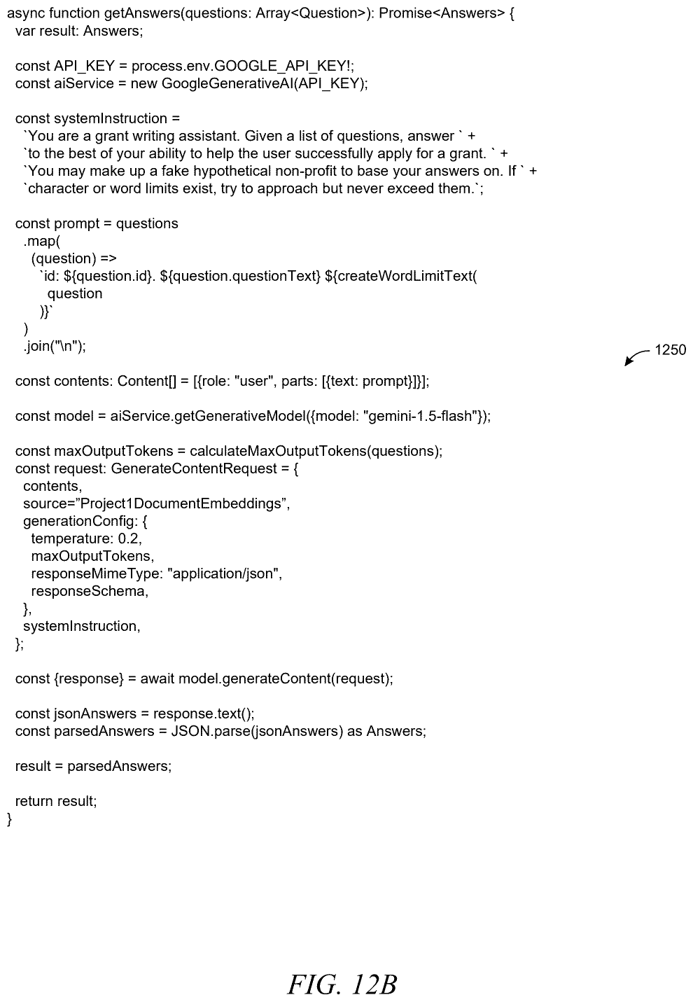

At step 414 of FIG. 4, the application assistance server 102 (for example, the communication module 202) may provide the one or more inputs and the documents associated with the selected boilerplate to the artificial intelligence model system 114. At step 416, the application assistance server 102 (for example, the communication module 202) may receive one or more responses to the one or more inputs. The one or more responses may include one or more answers that the artificial intelligence model system generated using the one or more documents associated with the selected boilerplate. FIGS. 12A and 12B depict example software code 1200 and example software code 1250 that the application assistance server 102 may utilize to generate inputs to the artificial intelligence model system 114 based on application questions and documents and receive responses to the inputs in some embodiments.

At step 418, the application assistance server 102 (for example, the application module 204) may provide the one or more answers in the grant application 610. FIG. 6G depicts the grant application 610 with the answers generated by the artificial intelligence model system 114 displayed in the appropriate fields of the grant application 610. The user may view the answers and modify the answers to the grant application questions 506. For example, the user may edit, replace, or otherwise change the answers to the grant application 610. If the user is satisfied with the answers to the grant application questions 506, the user may set the status 614 of the grant application 610 using the button 616. As depicted in FIG. 6H, the user may set the status 614 to “Not Started,” “In Progress,” “Pending Approval,” “Complete,” “Submitted,” “Denied,” or “Awarded.” The user may also set the expected funding amount 618 expected for the grant application 610. FIG. 6I depicts the user interface 300 with the grant application 610 shown in the listing 602 in the grant application section 334 with the status 614 set to “Pending Approval” and the expected funding amount 618 set to “$10,000.” The application assistance server 102 (for example, the application module 204) also may have updated the number of grant applications pending approval and the total expected funding for the grant applications.

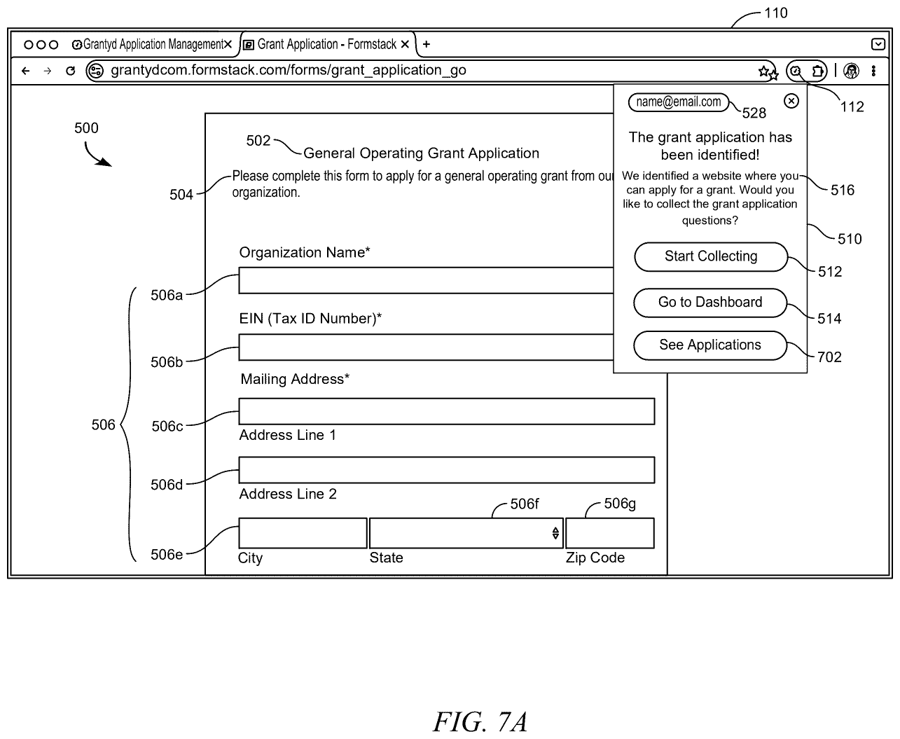

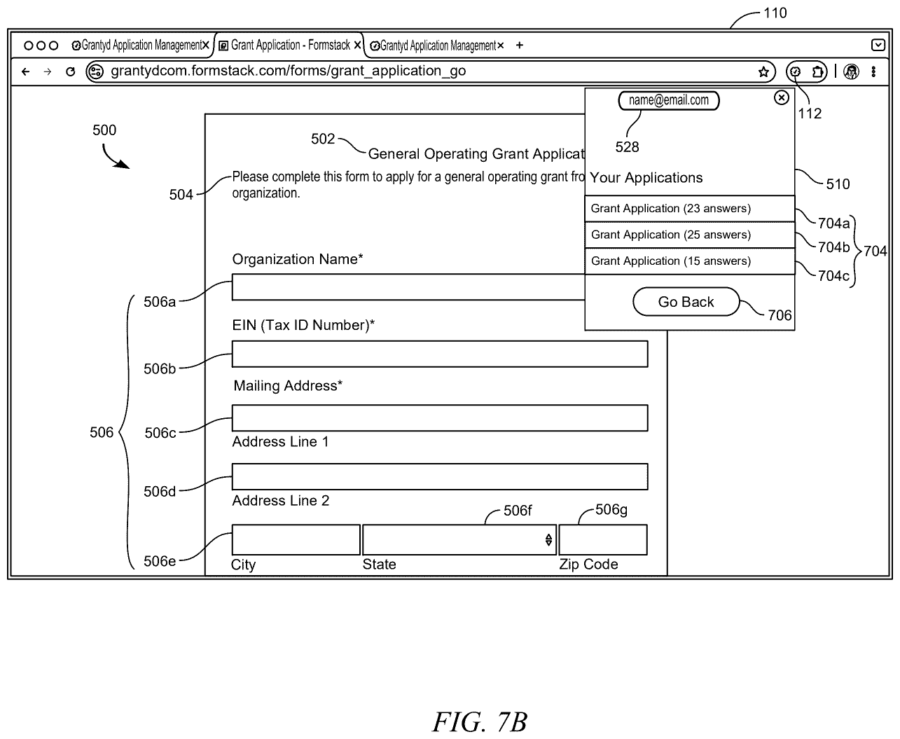

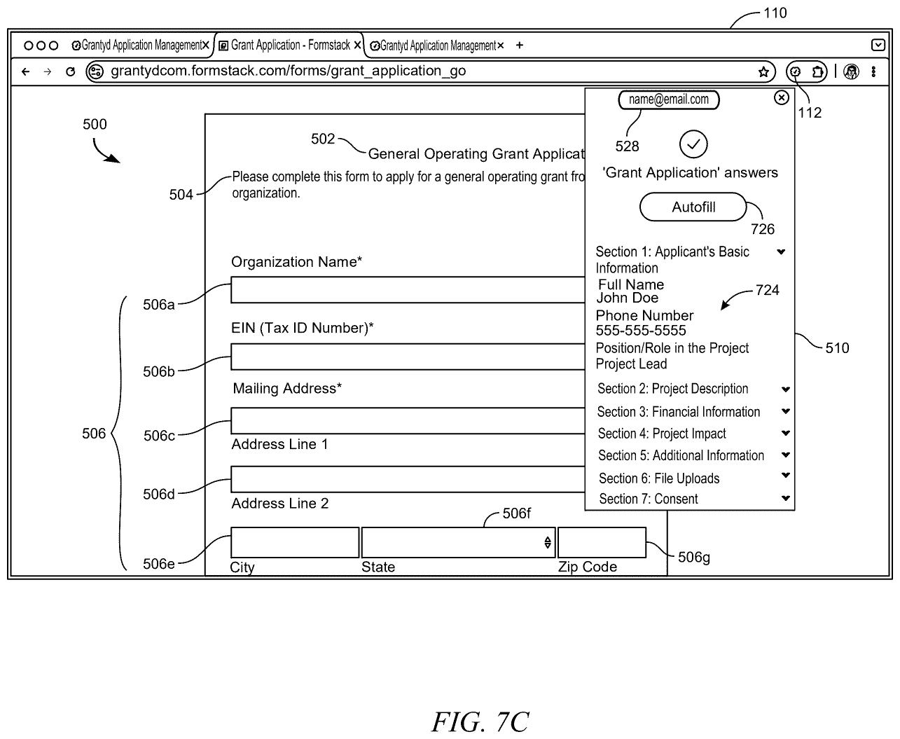

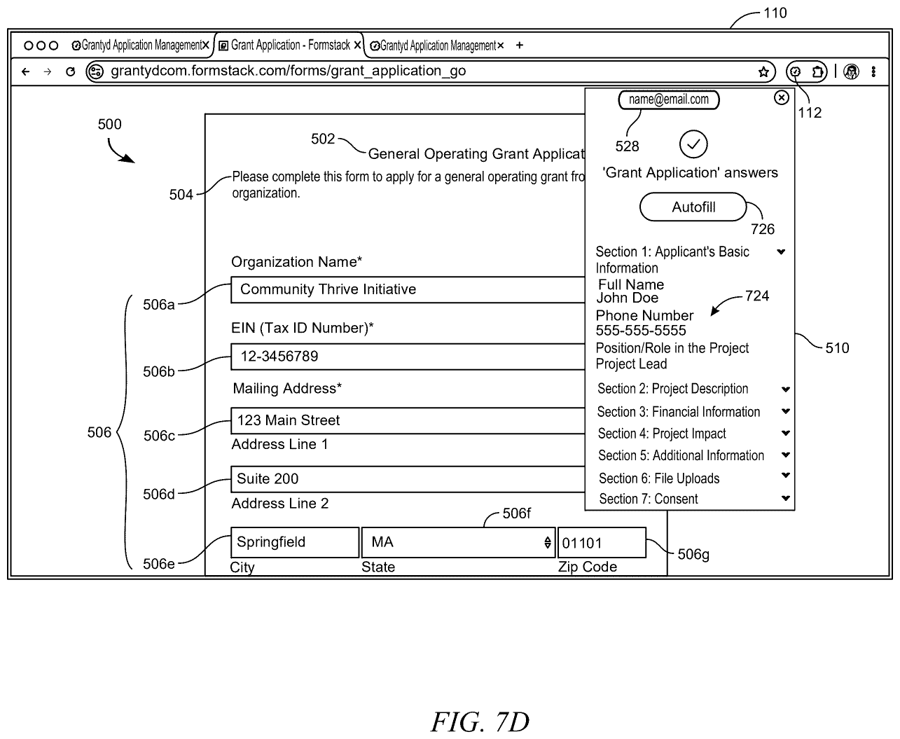

To submit the grant application, the user may return to the grant application 500 at the grant application website. FIG. 7A depicts the grant application 500 and the overlay 510. The application assistance browser extension 112 may update the overlay 510 to include a button 702, labeled “See Applications.” The application assistance browser extension 112 (for example, the application module 224) may determine that the grant application 500 is associated with the grant application 610 stored at the application assistance server 102, and provide the button 702 for display in the overlay 510 in response to the determination. The application assistance browser extension 112 may utilize the website URL, text on the web page (for example, the name 502 of the grant application 500), the grant application questions 506, or some combination of the foregoing to determine that a grant application at a grant application website is associated with a grant application stored at the application assistance server 102.

The user may select the button 702, which may cause the application assistance browser extension 112 (for example, the user interface module 226) to update the overlay 510 to show grant applications stored at the application assistance server 102 that are associated with the grant application 500. FIG. 7B depicts grant applications 704 (shown individually as grant application 704a, grant application 704b, and grant application 704c) that include answers to the grant application questions 506. The user may select one of the grant applications 704 or select the button 706 labeled “Go Back” to return to the overlay 510 as displayed in FIG. 7A. The user may select one of the grant applications 704, such as the grant application 704c, which may cause the application assistance browser extension 112 (for example, the user interface module 226) to update the overlay 510 to provide for display the answers 724 to the grant application questions 506 generated by the artificial intelligence model system 114, as depicted in FIG. 7C. The user may scroll through the overlay 510 to review the answers 724. In some embodiments, the application assistance browser extension 112 may allow the user to modify the answers 724 in the overlay 510.

Returning to FIG. 4, at step 420 the application assistance browser extension 112 (for example, the user interface module 226) may receive a request to automatically provide the answers 724 to the grant application questions 506 in the grant application 500 at the grant application website. As depicted in FIG. 7C, the user may select the button 726 labeled “Auto Fill” to have the application assistance browser extension 112 (for example, the application module 224) automatically provide the answers 724 to the grant application questions 506 in the grant application 500 at the grant application website. The answers 724 may be those as generated by the artificial intelligence model system 114 or as modified by the user in the grant application 610. The application assistance server 102 may provide the answers 724 to the application assistance browser extension 112, as well as any information associated with the answers 724, such as the particular form field that an answer of the answers 724 is associated with. Returning to FIG. 4, at step 422 the application assistance browser extension 112 (for example, the application module 224) may automatically provide (such as without any further input by the user) the answers 724 to the grant application questions 506 in the grant application 500 at the grant application website.

FIG. 7D displays the grant application 500 with the answers 724 in the fields of the grant application questions 506. FIG. 11E depicts example software code 1180 that the application assistance browser extension 112 of the application assistance system may utilize to provide the answers 724 in the fields of the grant application questions 506. One technical problem faced in providing answers to grant application questions relates to how to provide the proper answers in the fields of the grant application questions. One technical solution to this technical problem may involve the application assistance browser extension 112 utilizing the one or more DOMs of the web page to identify the HTML form element and form elements of the HTML form element, such as the input elements and textarea elements, and their properties, such as their identifiers. For a form element, the application assistance browser extension 112 may utilize the form element properties (for example, the identifier) to determine which answer of the answers 724 is associated with the form element. As noted above, the application assistance browser extension 112 may have received this information from the application assistance server 102.

The application assistance browser extension 112 may utilize the one or more DOMs of the web page to iterate through each document element of the web page, including the document element(s) for any iframe(s) of the web page. The application assistance browser extension 112 may utilize the one or more DOMs of the web page. The application assistance browser extension 112 may utilize the filtered list of iframes to only iterate through the document of those iframes that the application assistance browser extension 112 previously determined likely included application questions. In this context as well, the use of a filtered list of iframes may save significant computing resources, such as processing or memory resources, as the application assistance browser extension 112 does not need to iterate through such iframes. Accordingly, such techniques of the application assistance browser extension 112 may provide significant improvements to computing technology.

As previously noted, if the grant application 500 spans more than one web page or is displayed on more than one web page, the application assistance browser extension 112 may provide the answers 724 to the grant application questions 506 on each web page of the grant application 500. In such cases, only a subset of the grant application questions may be visible to the user on a web page, with the remainder of the application questions being part of the software code of the web page but hidden from the user. By utilizing the one or more DOMs, the application assistance browser extension 112 may detect the grant application questions 506 that are visible and grant application questions that are hidden. The application assistance browser extension 112 may detect properties or attributes of form elements or associated elements using the DOM to determine if the grant application questions are visible or hidden. Additionally or alternatively, the application assistance browser extension 112 may utilize the stored association of grant application questions with the web page that the grant application questions are visible on to provide the answers 724 to the grant application questions 506. The application assistance browser extension 112 may also automatically select the button or other form element to advance from one web page to the next web page, until the application assistance browser extension 112 reaches the web page where submission of the grant application 500 may occur.

The user may review the answers 724 in the grant application questions 506 fields. Once the user is satisfied, the user may submit the grant application 500 at the grant application website. The application organization system 106 may thus receive the grant application 500 as completed and review the grant application 500 as completed. In some embodiments, the application assistance browser extension 112 may detect the submission of the grant application 500 and automatically update the status 614 to “Submitted” in the application management subsystem 118 for display in the user interface 300.

The method 400 of FIG. 4 may include additional steps, such as a step 424 in which the application assistance server 102 (for example, the user interface module 208) may receive an expected funding amount for the grant application 610, a step 426 in which the application assistance server 102 (for example, the user interface module 208) may receive a status of the grant application 610, a step 428 in which the application assistance server 102 (for example, the application module 204) may store the expected funding amount for the grant application 610 and the status of the grant application 610 in association with the grant application 610, and a step 430 in which the application assistance server 102 (for example, the user interface module 208) may provide for display an identifier of the grant application 610, the expected funding amount for the grant application 610, and the status of the grant application 610. Such steps may be described herein with respect to, for example, FIGS. 6F-6I, which depict, among other things, allowing the user to provide an expected funding amount for the grant application 610, a status of the grant application 610 and displaying the expected funding amount and the status of the grant application 610.

The method 400 of FIG. 4 may include additional steps, such as a step 432 in which the application assistance server 102 (for example, the application module 204) may determine a total number of grant applications stored by or at the application assistance server 102. The total number of grant applications may include the grant application 610 and one or more other grant applications. The method 400 may also include a step 434 in which the application assistance server 102 (for example, the application module 204) may determine a total expected funding amount of the grant applications stored by or at the application assistance server 102. The total expected funding amount of the grant applications may include the expected funding amount for the grant application 610 and one or more expected funding amounts for one or more other grant applications. The method 400 may also include a step 436 in which the application assistance server 102 (for example, the user interface module 208) may provide for display the total number of grant applications, the total expected funding amount of the grant applications, the identifier of the grant application 610, and one or more other identifiers of the one or other grant applications. Such steps may be described herein with respect to, for example, FIG. 6I, which depicts, among other things, the total number of grant applications stored by or at the application assistance server 102, the total expected funding amount of the grant applications stored by or at the application assistance server 102, and the identifier of the grant application 610.

The method 400 of FIG. 4 may include additional steps, such as a step 438 in which the application assistance server 102 (for example, the user interface module 208) may receive a request from the user to share the grant application 610 with another user and a step 440 in which the application assistance server 102 (for example, the user interface module 208) may share the grant application 610 with the other user. In some cases, both the user and the other user are an employee of the same organization. In some cases, either the user is a contractor or a consultant for an organization and the other user is an employee of the organization, or the user is an employee of the organization, and the other user is a contractor or a consultant for the organization. Other variations are possible. Such steps may be described herein with respect to, for example, FIGS. 6B and 6F-6H, which depict, among other things, a button 652 labeled “Export” for exporting the grant application 610 (for example, to a PDF or Word document file) and a button 654 labeled “Share” for sharing the grant application 610 (for example, with another user of the application assistance system).

The method 400 of FIG. 4 may include additional steps, such as a step in which the application assistance server 102 (for example, the document module 206) may receive multiple documents, a step in which the application assistance server 102 (for example, the user interface module 208) may receive a selection of one or more of the multiple documents as the documents to be used by the artificial intelligence model system 114 to generate the answers to the grant application questions 506, and a step in which the application assistance server 102 (for example, the document module 206) may identify the selected one or more of the multiple documents as the documents to be used by the artificial intelligence model system 114 to generate the answers to the grant application questions 506. Such steps may be described herein with respect to, for example, FIGS. 6C-6F, which depict, among other things, allowing the user to upload documents, to create a boilerplate, to associate one or more documents with the boilerplate, and to select the boilerplate in requesting that the artificial intelligence model system 114 generate the answers to the grant application questions 506.

As noted previously, existing systems for completing applications often suffer from several technical limitations. These include a lack of contextual understanding of the application content, no integration with user-provided documents, and no ability to automate the transfer of generated responses back into the original application. Users are typically required to manually interpret questions, search through relevant documents, and input answers, which is time-consuming, error-prone, and inefficient. Moreover, traditional form-filling tools lack the ability to dynamically adapt to the specific context of each application or leverage external knowledge sources in a meaningful way.

The application assistance system provides technical solutions to these technical problems by utilizing Retrieval Augmented Generation (RAG). The application assistance system enables the automatic extraction of application questions from web-based forms and leverages user-specified documents to generate contextually accurate answers using AI models. By incorporating RAG, the application assistance system retrieves relevant information from the user's documents and combines it with generative capabilities to produce tailored responses. This significantly reduces the cognitive and manual burden on the user, while improving the relevance and accuracy of the answers.

Additionally, the application assistance system provides a seamless feedback loop between the application website and the AI-generated answers. Through the application assistance browser extension 112, users can automatically populate the original application with the generated answers, eliminating the need for manual copying and pasting. The application assistance server 102 also supports application tracking, metadata management, and dashboard visualization, offering a comprehensive technical solution that enhances user productivity, reduces errors, and streamlines the entire application process. This represents a significant advancement over existing systems by tightly integrating AI, document retrieval, and user interface automation into a cohesive and intelligent workflow.

The embodiments of the application assistance system described with reference to FIGS. 1-7D provides numerous advantages to users. One advantage is that the user may save significant amounts of time in preparing and submitting grant applications. Another advantage is that users within an organization may collaborate with each other on grant applications. Another advantage is that organization leaders may have visibility into metrics that are important to the organization, such as the number of grant applications the organization is working on, the number of grant applications that are pending approval, and the total amount of expected funding. As certain organizations, such as non-profits, may be resource-constrained, such advantages may provide important benefits to help these organizations fulfill their missions. Other advantages may be apparent.

In some embodiments of the application assistance system, the application assistance system may include a browser extension and a server that may interface with artificial intelligence (AI) or machine learning (ML) systems. When a person is writing or filling out an application on a web page, the person may provide documents that are relevant to the application to the browser extension. The browser extension may provide the documents to the server. The server may cause embeddings to be generated of the documents by the artificial intelligence or machine learning systems.

During the application process, the browser extension may detect application questions on web pages. The browser extension may provide the application questions to the server. The server may generate inputs to a large language model based on the application questions. The server may provide the inputs and the document embeddings to the large language model. The large language model may generate responses to the inputs based on the document embeddings and may provide the responses to the server. The responses may include answers to the application questions.

The server may receive the responses from the large language model and may provide the answers to the browser extension. The browser extension may provide the answers to the application questions on the web page. The application assistance system thus answers application questions without the person having to manually copy and paste information and without the person having to switch back and forth between documents and the application web pages. The application assistance system may automate the repetitive and time-consuming task of filling out applications.

An example use case involves a person writing grant applications for a particular project. The person may provide a variety of documents (proposals, budgets, mission statements, past reports, etc.) to the application assistance system to create a knowledge base for the particular project. Grant applications often may include the same or similar questions (for example, “What is your organization's mission?”), the answers to which are often found in the project documents or may be derived from the project documents. As the person may be filling out the grant applications in their browser, the browser extension of the application assistance system may detect the grant application questions.

The application assistance system may obtain answers to the grant application questions from a large language model that may utilize embeddings of the project documents to answer the grant application questions. The browser extension may then automatically populate form fields on grant application web pages with the answers. The application assistance system thus saves the person having to spend time manually copying and pasting information from documents to grant applications.

The application assistance system also avoids the person having to frequently switch contexts (for example, from project documents to grant applications and from grant applications to project documents) while filling out the grant applications. The application assistance system also reduces or minimizes errors by automatically filling out form fields with the appropriate information from the project documents.

Grant writers across all industries and sectors, non-profit organizations reliant on grant funding, and independent consultants specializing in grant proposal development may benefit from the application assistance system.

Other example use cases are authoring research grant applications, filling out job applications, and filling out college applications. Without the application assistance system, a person filling out such applications may have to spend hours manually copying and pasting information from relevant documents (for example, scientific papers in the case of research grant applications, resumes in the case of job applications, and essays or biographical information in the case of college applications). The application assistance system may detect the application questions and utilizes the relevant documents to obtain answers to the application questions and automatically provide the answers to the application questions for the person.

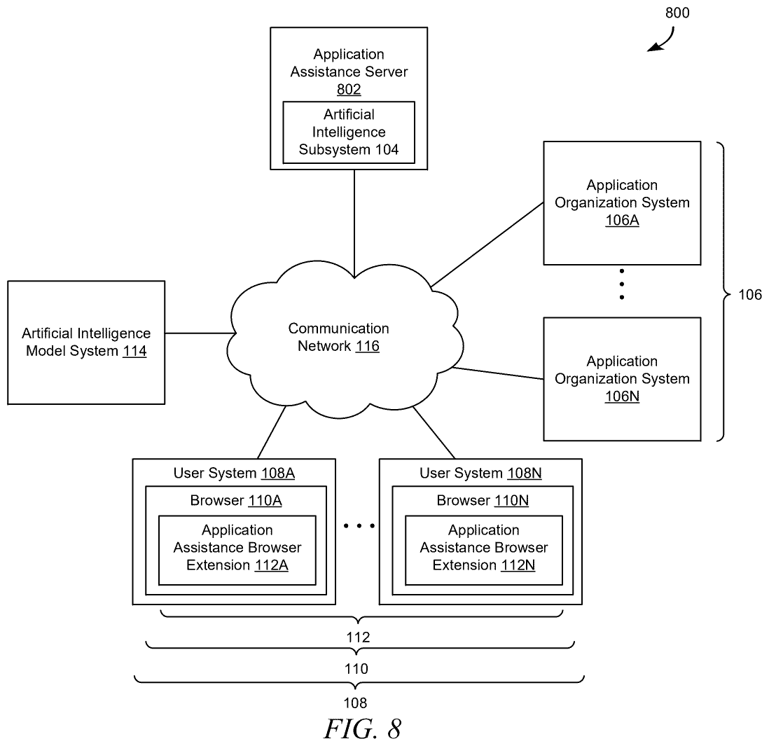

FIG. 8 is a block diagram depicting another example environment 800 in which an application assistance system may operate according to some embodiments. The environment 800 may be generally similar to the environment 100 of FIG. 1, and the functionality of the systems or servers depicted in FIG. 8 may be the same as or generally similar to those systems or servers depicted in FIG. 1. One difference between the environment 800 and the environment 100 is that an application assistance server 802 may not include the application management subsystem 118.

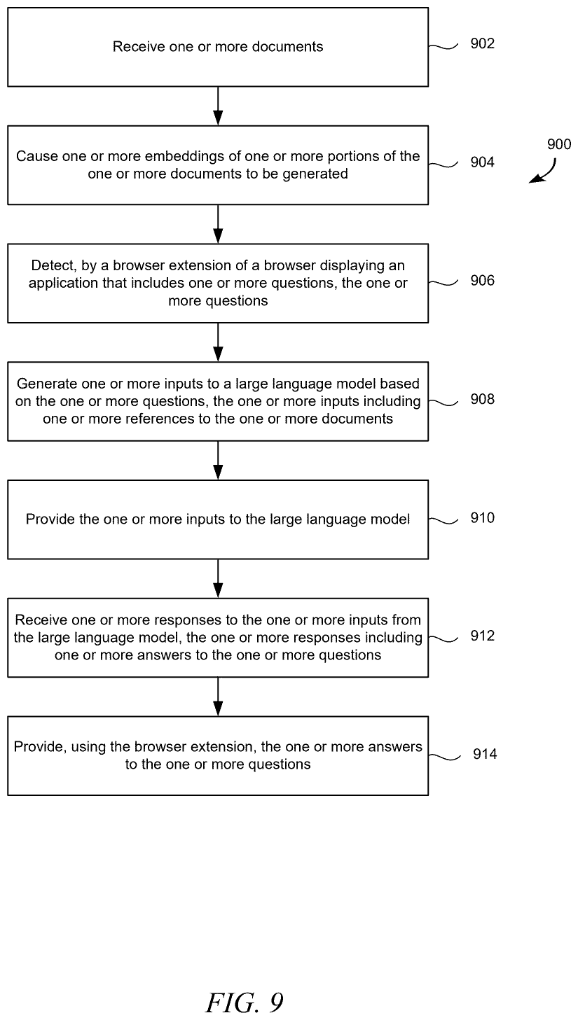

FIG. 9 depicts a method 900 for generating answers to application questions in some embodiments. The method 900 may be performed by the application assistance system, such as by the application assistance server 802, the artificial intelligence subsystem 104, or the application assistance browser extension 112. The method 900 may be described using the example of a person writing one or more grant applications. However, the method 900 may be applicable to other persons filling out or writing other applications, such as research grant applications, employment applications, educational applications, or government applications.

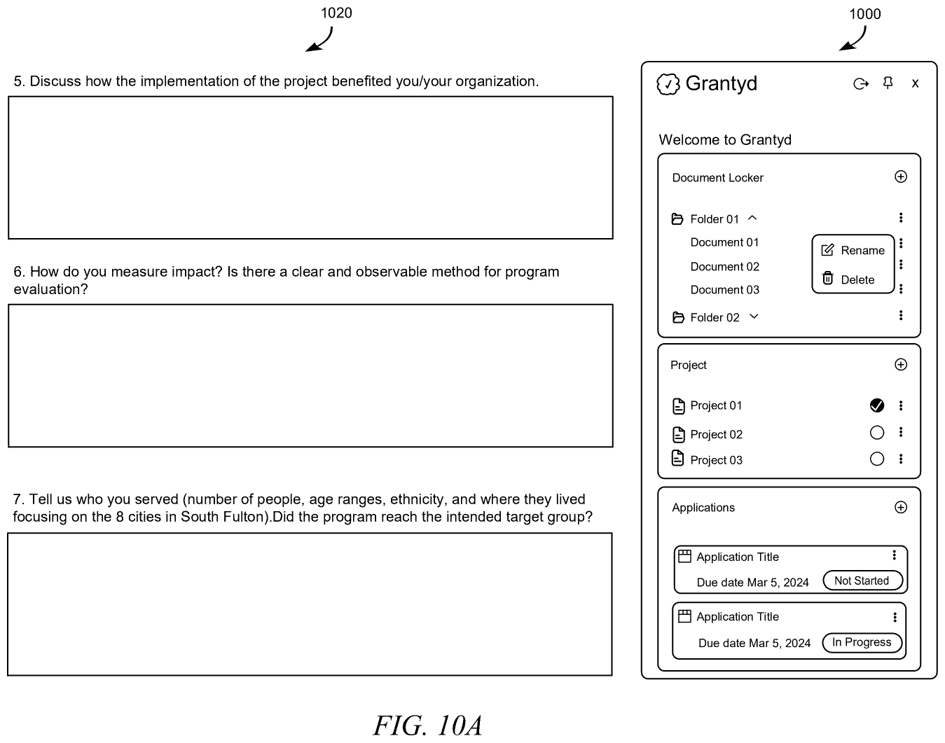

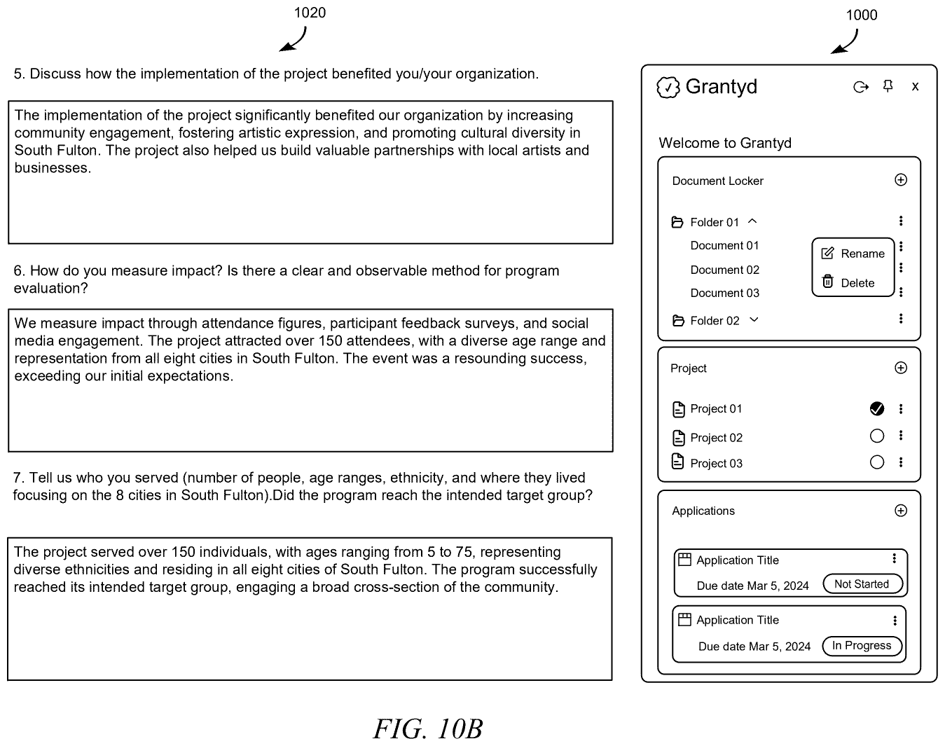

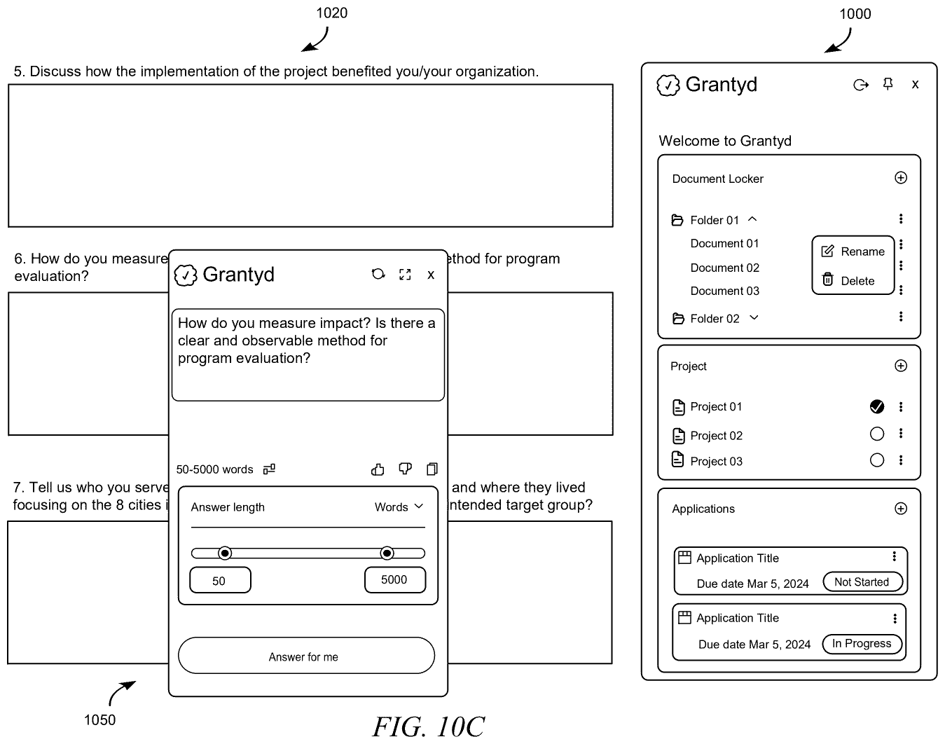

The method 900 may begin at a step 902, where the application assistance browser extension 112 may receive one or more documents from the user. FIG. 10A depicts an example interface 1000 that the application assistance browser extension 112 may provide in the same browser window in which the browser 110 is displaying a grant application web page. The application assistance browser extension 112 may provide the interface 1000 as a side panel or as a popup window. The interface 1000 may allow the user to upload documents, such as proposals, budgets, mission statements, and reports, from the user system 108 or from a file hosting service to the application assistance server 802. The user may organize the documents into folders and assign documents to one or more projects. The user may also assign one or applications to a project.

At a step 904 the application assistance server 802 may cause one or more embeddings of one or more portions of the one or more documents to be generated. For example, the artificial intelligence subsystem 104 may provide the documents to the artificial intelligence model system 114 and request that the artificial intelligence model system 114 create embeddings, such as vectorized embeddings, of the documents. The artificial intelligence model system 114 may then store the embeddings in a datastore. The artificial intelligence subsystem 104 may divide the one or more documents into one or more portions (for example, by paragraphs) and have the artificial intelligence model system 114 create embeddings of the resulting paragraphs.

At a step 906 the application assistance browser extension 112 may detect one or more questions of a grant application on a web page that the browser 110 of the user system 108 is displaying. FIG. 10A also depicts grant application questions 1020 that the browser 110 may display. The application assistance browser extension 112 may detect the one or more questions of the grant application on one or more web pages. The application assistance browser extension 112 may detect the one or more questions by parsing one or more document object models (DOMs) to identify form fields that accept text input, such as text input and text area elements.

The application assistance browser extension 112 may then obtain the identifiers of the text input and text area elements and use the identifiers to determine the corresponding labels of the text of the questions for the text input and text area elements. A text input or a text area element may also have a word or character limit. If so, the application assistance browser extension 112 may detect the word or character limits for the text input and text area elements.

At a step 908 the artificial intelligence subsystem 104 may generate one or more inputs to a large language model of the artificial intelligence model system 114 based on the one or more questions. The one or more inputs may include one or more references to one or more documents that are associated with the project that the grant application is associated with. For example, the one or more inputs may include one or more references to embeddings of the one or more documents that are associated with the project that the grant application is associated with. The one or more inputs may also include the word or character limits as an optional parameter.

At a step 910 the artificial intelligence subsystem 104 may provide the one or more inputs to the large language model. At a step 912 the artificial intelligence subsystem 104 may receive one or more responses to the one or more inputs from the large language model. The one or more responses may include one or more answers to the one or more questions. At a step 914 the application assistance browser extension 112 may provide the one or more answers to the one or more questions in the grant application. FIG. 10B depicts the grant application questions 1020 with responses provided that were generated by the artificial intelligence subsystem 104.

The application assistance browser extension 112 may detect if a grant application is arranged across several web pages and be able to provide answers to questions on each web page. While the user is filling out a grant application, the application assistance browser extension 112 may show the application status as in progress in the interface 1000. The application assistance browser extension 112 may also detect when the user submits the application. The application assistance browser extension 112 may then update the application status to show that the application has been completed. In some embodiments, the application assistance system may be able to interface with the application organization system 106 to determine if or when a grant application has been acted upon and the result (approval, disapproval, or partial approval). In such cases, the application assistance browser extension 112 may provide the result in the interface 1000.

Certain grant application web pages may not allow the application assistance browser extension 112 to access the DOM. In such cases, the application assistance browser extension 112 may allow a user to highlight the text of a question and request that the text question be answered. The application assistance browser extension 112 may send the question text to the application assistance server 802, which may generate an input to the large language model based on the question text, and requests that the large language model answer the question.

After receiving a response that may include an answer from the large language model, the application assistance server 802 may send the answer to the application assistance browser extension 112. The application assistance browser extension 112 may allow the user to copy the question answer and paste the question answer into the appropriate form field.

FIG. 10C depicts an interface 1050 that the application assistance browser extension 112 may provide in such cases. The user may select question text and the application assistance browser extension 112 may place the selected question text in the interface 1050 and allow the user to request that the application assistance system answer the question. The interface 1050 may also allow the user to specify a range for an answer length, either by words or characters. The interface 1050 may also allow the user to approve or disapprove the quality of the answer. The application assistance system may use such user feedback to improve upon subsequent answers to grant application questions.

Alternative approaches to the above are possible. For example, in addition to or as an alternative to using embeddings, the application assistance system may identify documents relevant to an application question, obtain the relevant text from the identified documents, and provide the relevant text along with the application question to the large language model as an input. The large language model may then utilize the relevant text and the application question to generate a response to the input.

As described herein, the application assistance system provides numerous technical solutions to technical problems. Such technical solutions provide numerous advantages. One advantage is that the application assistance browser extension 112 may provide seamless interfaces in the same browser in which a person is writing or filling out an application. This allows the person to stay in the same context while writing or filling out the application and allows the person to avoid having to switch back and forth between the browser window and the person's supporting documents. Another advantage is that the person does not have to spend time manually copying and pasting information from documents to applications. Accordingly, the application assistance system may provide significant time savings for the person.

The application assistance system may also reduce or minimize errors by automatically generating answers to application questions with the appropriate information from the relevant documents. Accordingly, the application assistance system may improve the accuracy of applications that the person fills out or completes.

Another advantage of the application assistance system is that a user can quickly and easily organize documents that may be utilized to fill out applications and specify a subset of documents to be used to generate answers to application questions. Accordingly, the application assistance system enhances organization and enables efficient management of diverse applications, such as different grant applications, with customized document sets. Other advantages of the application assistance system will be apparent.

Another advantage of the application assistance system is that the application assistance system may be utilized for assistance in a wide variety of application types. For example, the application assistance system may be used to provide assistance with filling out or completing education applications such as college applications, filling out or completing employment applications, filling out or completing housing applications such as rental housing applications, filling out or completing government applications such as visa or citizenship applications, filling out or completing financial aid applications, filling out or completing loan applications, filling out or completing insurance applications, or filling out or completing business license applications. Without the application assistance system, a person filling out such an application may have to spend hours manually copying and pasting information from relevant documents (for example, financial statements in the case of loan applications, resumes in the case of employment applications, and essays or biographical information in the case of education applications). The application assistance system may obtain the application questions from the application at hand, utilize the relevant documents to obtain answers to the application questions, and automatically provide the answers to the application questions. Accordingly, the application assistance system is applicable to providing assistance with filling out or completing various types of applications or forms.

Various aspects of the application assistance system are described herein. In some aspects, the techniques described herein relate to a method including: receiving, by an application assistance browser extension, a request to obtain grant application questions in a first grant application at a grant application website; obtaining, by the application assistance browser extension, the grant application questions from the first grant application; generating, by an application assistance server, a second grant application that includes the grant application questions; receiving, by the application assistance server, one or more documents, the one or more documents including information usable to answer at least some of the grant application questions; receiving, by the application assistance server, a request to have an artificial intelligence model system generate one or more answers to at least some of the grant application questions; generating, by the application assistance server, based on the request to have the artificial intelligence model system generate the one or more answers, one or more inputs to the artificial intelligence model system, the one or more inputs specifying that the artificial intelligence model system is to use the one or more documents to generate the one or more answers; providing, by the application assistance server, the one or more inputs and the one or more documents to the artificial intelligence model system; receiving, by the application assistance server, one or more responses to the one or more inputs, the one or more responses including the one or more answers, the one or more answers generated by the artificial intelligence model system using the one or more documents; providing, by the application assistance server, the one or more answers in the second grant application; receiving, by the application assistance browser extension, a request to provide the one or more answers to the grant application questions in the first grant application at the grant application website; and automatically providing, by the application assistance browser extension, the one or more answers to the grant application questions in the first grant application at the grant application website.

In some aspects, the techniques described herein relate to a method, further including receiving, by the application assistance server, one or more modifications to the one or more answers in the second grant application to obtain one or more modified answers, wherein automatically providing, by the application assistance browser extension, the one or more answers to the grant application questions in the first grant application at the grant application website includes automatically providing, by the application assistance browser extension, the one or more modified answers to the grant application questions in the first grant application at the grant application website.

In some aspects, the techniques described herein relate to a method wherein the one or more documents are one or more first documents, and further including: receiving, by the application assistance server, multiple second documents; receiving, by the application assistance server, a selection of one or more second documents as the one or more first documents to be used by the artificial intelligence model system to generate the one or more answers; and identifying, by the application assistance server, the one or more second documents as the one or more first documents to be used by the artificial intelligence model system to generate the one or more answers.

In some aspects, the techniques described herein relate to a method, further including: receiving, by the application assistance server, an expected funding amount for the second grant application; receiving, by the application assistance server, a status of the second grant application; storing, by the application assistance server, the expected funding amount for the second grant application and the status of the second grant application in association with the second grant application; and providing for display, by the application assistance server, an identifier of the second grant application, the expected funding amount for the second grant application, and the status of the second grant application.

In some aspects, the techniques described herein relate to a method, further including: determining, by the application assistance server, a total number of grant applications, the total number of grant applications including the second grant application and one or more third grant applications; determining, by the application assistance server, a total expected funding amount of the grant applications, the total expected funding amount of the grant applications including the expected funding amount for the second grant application and one or more expected funding amounts for the one or more third grant applications; and providing for display, by the application assistance server, the total number of grant applications, the total expected funding amount of the grant applications, the identifier of the second grant application, and one or more identifiers of the one or more third grant applications.

In some aspects, the techniques described herein relate to a method, further including: utilizing, by the application assistance browser extension, one or more Document Object Models (DOMs) of one or more HTML web pages at the grant application website to identify the grant application questions in the first grant application; and utilizing, by the application assistance browser extension, the one or more DOMs to automatically provide, by the application assistance browser extension, the one or more answers to the grant application questions in the first grant application at the grant application website.

In some aspects, the techniques described herein relate to a method wherein utilizing, by the application assistance browser extension, the one or more DOMs of the one or more HTML web pages at the grant application website to identify the grant application questions includes: generating a data structure that includes one or more iframes of the one or more HTML web pages; filtering the data structure to remove iframes that do not meet one or more criteria to obtain a filtered data structure; and utilizing the iframes in the filtered data structure to identify at least one of the grant application questions.

In some aspects, the techniques described herein relate to a method, further including: receiving, by the application assistance server, a request from a first user to share the second grant application with a second user; and sharing, by the application assistance server, the second grant application with the second user.

In some aspects, the techniques described herein relate to a method wherein the first user and the second user are both an employee of an organization.

In some aspects, the techniques described herein relate to a method wherein either the first user is a contractor or a consultant for an organization and the second user is an employee of the organization or the first user is an employee of the organization and the second user is a contractor or a consultant for the organization.

In some aspects, the techniques described herein relate to one or more non-transitory computer-readable media including executable instructions that when executed by one or more processors of a system cause the system to perform a method including: receiving a request to obtain grant application questions in a grant application document; obtaining the grant application questions from the grant application document; generating a grant application that includes the grant application questions; receiving one or more documents, the one or more documents including information usable to answer at least some of the grant application questions; receiving a request to have an artificial intelligence model system generate one or more answers to at least some of the grant application questions; generating, based on the request to have the artificial intelligence model system generate the one or more answers, one or more inputs to the artificial intelligence model system; providing the one or more inputs and the one or more documents to the artificial intelligence model system, the one or more inputs specifying that the artificial intelligence model system is to use the one or more documents to generate the one or more answers; receiving one or more responses to the one or more inputs, the one or more responses including the one or more answers, the one or more answers generated by the artificial intelligence model system using the one or more documents; providing the one or more answers in the grant application; receiving a request to provide the one or more answers to the grant application questions in the grant application document; and providing the one or more answers to the grant application questions in the grant application document.

In some aspects, the techniques described herein relate to one or more non-transitory computer-readable media, the method further including receiving one or more modifications to the one or more answers in the grant application to obtain one or more modified answers, wherein providing the one or more answers to the grant application questions in the grant application document includes providing the one or more modified answers to the grant application questions in the grant application document.

In some aspects, the techniques described herein relate to one or more non-transitory computer-readable media wherein the one or more documents are one or more first documents, and further including: receiving multiple second documents; receiving a selection of one or more second documents as the one or more first documents; and identifying the one or more second documents as the one or more first documents.

In some aspects, the techniques described herein relate to one or more non-transitory computer-readable media, the method further including: receiving an expected funding amount for the grant application; receiving a status of the grant application; storing the expected funding amount for the grant application and the status of the grant application in association with the grant application; and providing for display an identifier of the grant application, the expected funding amount for the grant application, and the status of the grant application.

In some aspects, the techniques described herein relate to one or more non-transitory computer-readable media wherein the grant application is a first grant application, and the method further includes: determining a total number of grant applications, the total number of grant applications including the first grant application and one or more second grant applications; determining a total expected funding amount of the grant applications, the total expected funding amount of the grant applications including the expected funding amount for the first grant application and one or more expected funding amounts for the one or more second grant applications; and providing for display the total number of grant applications, the total expected funding amount of the grant applications, the identifier of the first grant application, and one or more identifiers of the one or more second grant applications.

In some aspects, the techniques described herein relate to one or more non-transitory computer-readable media, the method further including: receiving a request from a first user to share the grant application with a second user; and sharing the grant application with the second user.

In some aspects, the techniques described herein relate to one or more non-transitory computer-readable media wherein the grant application document includes a Hypertext Markup Language document (HTML document) that is provided by a grant application website.

In some aspects, the techniques described herein relate to one or more non-transitory computer-readable media wherein obtaining the grant application questions from the grant application document includes obtaining the grant application questions from the HTML document at the grant application website and providing the one or more answers to the grant application questions in the grant application document includes providing the one or more answers to the grant application questions in the HTML document at the grant application website.

In some aspects, the techniques described herein relate to one or more non-transitory computer-readable media, the method further including: utilizing one or more Document Object Models (DOMs) of the HTML document to obtain the grant application questions; and utilizing the one or more DOMs to automatically provide the one or more answers to the grant application questions in the HTML document.

In some aspects, the techniques described herein relate to one or more non-transitory computer-readable media wherein utilizing the one or more DOMs of the HTML document to obtain the grant application questions includes: generating a data structure that includes one or more iframes of the HTML document that meet one or more criteria; and utilizing the one or more iframes in the data structure to obtain at least one of the grant application questions.

In some aspects, the techniques described herein relate to one or more non-transitory computer-readable media wherein the grant application document includes one of a Portable Document Format (PDF) document and a document file format document.

In some aspects, the techniques described herein relate to a system including at least one processor and at least one memory including executable instructions that when executed by the at least one processor cause the system to: receive a request to obtain application questions in an application document; obtain the application questions from the application document; generate an application that includes the application questions; receive one or more documents, the one or more documents including information usable to answer at least some of the application questions; receive a request to have an artificial intelligence model system generate one or more answers to at least some of the application questions; generate, based on the request to have the artificial intelligence model system generate the one or more answers, one or more inputs to the artificial intelligence model system; provide the one or more inputs and the one or more documents to the artificial intelligence model system; receive one or more responses to the one or more inputs, the one or more responses including the one or more answers, the one or more answers generated by the artificial intelligence model system using the one or more documents; provide the one or more answers in the application; receive a request to provide the one or more answers to the application questions in the application document; and provide the one or more answers to the application questions in the application document.

In some aspects, the techniques described herein relate to a system wherein the application document is one of a grant application document, an employment application document, an education application document, and a housing application document.

In some aspects, the techniques described herein relate to a system wherein the application document includes a Hypertext Markup Language document (HTML document) that is provided by an application website.

In some aspects, the techniques described herein relate to a system wherein the executable instructions that when executed by the at least one processor further cause the system to: utilize one or more Document Object Models (DOMs) of the HTML document to obtain the application questions; and utilize the one or more DOMs to automatically provide the one or more answers to the application questions in the HTML document.

In some aspects, the techniques described herein relate to a system wherein the executable instructions that when executed by the at least one processor that further cause the system to utilize the one or more DOMs of the HTML document to obtain the application questions include executable instructions that when executed by the at least one processor further cause the system to: generate a data structure that includes one or more iframes of the HTML document that meet one or more criteria; and utilize the one or more iframes in the data structure to obtain at least one of the application questions.

FIG. 13 depicts a block diagram of an example digital device 1300 according to some embodiments. The digital device 1300 is shown in the form of a general-purpose computing device. The digital device 1300 includes at least one processor 1302, RAM 1304, communication interface 1306, input/output device 1308, storage 1310, and a system bus 1312 that couples various system components including storage 1310 to the at least one processor 1302. A system, such as a computing system, may be or include one or more of the digital device 1300.

System bus 1312 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 1300 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 1302 is configured to execute executable instructions (for example, programs). In some embodiments, the at least one processor 1302 comprises circuitry or any processor capable of processing the executable instructions.

In some embodiments, RAM 1304 stores programs or data. In various embodiments, working data is stored within RAM 1304. The data within RAM 1304 may be cleared or ultimately transferred to storage 1310, such as prior to reset or powering down the digital device 1300.

In some embodiments, the digital device 1300 is coupled to a network, such as the communication network 116, via communication interface 1306. The digital device 1300 can communicate with one or more networks such as a local area network (LAN), a general wide area network (WAN), or a public network (for example, the Internet).

In some embodiments, input/output device 1308 is any device that inputs data (for example, mouse, keyboard, stylus, sensors, etc.) or outputs data (for example, speaker, display, virtual reality headset).

In some embodiments, storage 1310 can include computer system readable media in the form of non-volatile memory, such as read only memory (ROM), programmable read only memory (PROM), solid-state drives (SSD), flash memory, or cache memory. Storage 1310 may further include other removable/non-removable, volatile/non-volatile computer system storage media. By way of example only, storage 1310 can be provided for reading from and writing to a non-removable, non-volatile magnetic media. The storage 1310 may include a non-transitory computer-readable medium, or multiple non-transitory computer-readable media, which stores programs or applications for performing functions such as those described herein. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 1312 by one or more data media interfaces. As will be further depicted and described below, storage 1310 may include at least one program product having a set (for example, at least one) of program modules that are configured to carry out the functions of embodiments of the technology. In some embodiments, RAM 1304 is found within storage 1310.

Programs/utilities, having a set (at least one) of program modules, such as the application assistance system, may be stored in storage 1310 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions or methodologies of embodiments of the technology as described herein.

It should be understood that although not shown, other hardware or software components could be used in conjunction with the digital device 1300. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a circuit, module or system. Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present technology may be written in any combination of one or more programming languages, including an object-oriented programming language such as Java, Smalltalk, C++, Python, or the like and conventional procedural programming languages, such as the C programming language or similar programming languages. The computer program code may execute entirely on any of the systems described herein or on any combination of the systems described herein.

Aspects of the present technology may be described with reference to flowchart illustrations or block diagrams of methods, apparatus (systems) and computer program products according to embodiments of the technology. It will be understood that each block of the flowchart illustrations or block diagrams, and combinations of blocks in the flowchart illustrations or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart or block diagram block or blocks.

While particular elements, embodiments and applications have been shown and described, it will be understood, of course, that the claims are not limited thereto since modifications may be made by those skilled in the art without departing from the spirit and scope of the present disclosure, particularly in light of the foregoing teachings. Such modifications are to be considered within the purview and scope of the claims appended hereto.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are only examples, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services,” and “providing products and services.”

Headings in this application may be provided for organization and may not necessarily be used to interpret or constrain the purview and scope of the claims appended hereto. Moreover, concepts or features of technologies described under a particular heading may be used in technologies described under other headings. Accordingly, technologies described under a particular heading are not limited to the concepts or features described under that particular heading.

It may be apparent that various modifications may be made, and other embodiments may be used without departing from the broader scope of the discussion herein. Therefore, these and other variations upon the example embodiments are intended to be covered by the disclosure herein.

1. A method comprising:
receiving, by an application assistance browser extension, a request to obtain grant application questions in a first grant application at a grant application website;
obtaining, by the application assistance browser extension, the grant application questions from the first grant application;
generating, by an application assistance server, a second grant application that includes the grant application questions;
receiving, by the application assistance server, one or more documents, the one or more documents including information usable to answer at least some of the grant application questions;
receiving, by the application assistance server, a request to have an artificial intelligence model system generate one or more answers to at least some of the grant application questions;
generating, by the application assistance server, based on the request to have the artificial intelligence model system generate the one or more answers, one or more inputs to the artificial intelligence model system, the one or more inputs specifying that the artificial intelligence model system is to use the one or more documents to generate the one or more answers;
providing, by the application assistance server, the one or more inputs and the one or more documents to the artificial intelligence model system;
receiving, by the application assistance server, one or more responses to the one or more inputs, the one or more responses including the one or more answers, the one or more answers generated by the artificial intelligence model system using the one or more documents;
providing, by the application assistance server, the one or more answers in the second grant application;
receiving, by the application assistance browser extension, a request to provide the one or more answers to the grant application questions in the first grant application at the grant application website; and
automatically providing, by the application assistance browser extension, the one or more answers to the grant application questions in the first grant application at the grant application website.

2. The method of claim 1, further comprising receiving, by the application assistance server, one or more modifications to the one or more answers in the second grant application to obtain one or more modified answers, wherein automatically providing, by the application assistance browser extension, the one or more answers to the grant application questions in the first grant application at the grant application website includes automatically providing, by the application assistance browser extension, the one or more modified answers to the grant application questions in the first grant application at the grant application website.

3. The method of claim 1 wherein the one or more documents are one or more first documents, and further comprising:
receiving, by the application assistance server, multiple second documents;
receiving, by the application assistance server, a selection of one or more second documents as the one or more first documents to be used by the artificial intelligence model system to generate the one or more answers; and
identifying, by the application assistance server, the one or more second documents as the one or more first documents to be used by the artificial intelligence model system to generate the one or more answers.

4. The method of claim 1, further comprising:
receiving, by the application assistance server, an expected funding amount for the second grant application;
receiving, by the application assistance server, a status of the second grant application;
storing, by the application assistance server, the expected funding amount for the second grant application and the status of the second grant application in association with the second grant application; and
providing for display, by the application assistance server, an identifier of the second grant application, the expected funding amount for the second grant application, and the status of the second grant application.

5. The method of claim 4, further comprising:
determining, by the application assistance server, a total number of grant applications, the total number of grant applications including the second grant application and one or more third grant applications;
determining, by the application assistance server, a total expected funding amount of the grant applications, the total expected funding amount of the grant applications including the expected funding amount for the second grant application and one or more expected funding amounts for the one or more third grant applications; and
providing for display, by the application assistance server, the total number of grant applications, the total expected funding amount of the grant applications, the identifier of the second grant application, and one or more identifiers of the one or more third grant applications.

6. The method of claim 1, further comprising:
utilizing, by the application assistance browser extension, one or more Document Object Models (DOMs) of one or more HTML web pages at the grant application website to identify the grant application questions in the first grant application; and
utilizing, by the application assistance browser extension, the one or more DOMs to automatically provide, by the application assistance browser extension, the one or more answers to the grant application questions in the first grant application at the grant application website.

7. The method of claim 6 wherein utilizing, by the application assistance browser extension, the one or more DOMs of the one or more HTML web pages at the grant application website to identify the grant application questions includes:
generating a data structure that includes one or more iframes of the one or more HTML web pages;
filtering the data structure to remove iframes that do not meet one or more criteria to obtain a filtered data structure; and
utilizing the iframes in the filtered data structure to identify at least one of the grant application questions.

8. The method of claim 1, further comprising:
receiving, by the application assistance server, a request from a first user to share the second grant application with a second user; and
sharing, by the application assistance server, the second grant application with the second user.

9. The method of claim 8 wherein the first user and the second user are both an employee of an organization.

10. The method of claim 8 wherein either the first user is a contractor or a consultant for an organization and the second user is an employee of the organization or the first user is an employee of the organization and the second user is a contractor or a consultant for the organization.

11. One or more non-transitory computer-readable media comprising executable instructions that when executed by one or more processors of a system cause the system to perform a method comprising:
receiving a request to obtain grant application questions in a grant application document;
obtaining the grant application questions from the grant application document;
generating a grant application that includes the grant application questions;
receiving one or more documents, the one or more documents including information usable to answer at least some of the grant application questions;
receiving a request to have an artificial intelligence model system generate one or more answers to at least some of the grant application questions;
generating, based on the request to have the artificial intelligence model system generate the one or more answers, one or more inputs to the artificial intelligence model system;
providing the one or more inputs and the one or more documents to the artificial intelligence model system, the one or more inputs specifying that the artificial intelligence model system is to use the one or more documents to generate the one or more answers;
receiving one or more responses to the one or more inputs, the one or more responses including the one or more answers, the one or more answers generated by the artificial intelligence model system using the one or more documents;
providing the one or more answers in the grant application;
receiving a request to provide the one or more answers to the grant application questions in the grant application document; and
providing the one or more answers to the grant application questions in the grant application document.

12. The one or more non-transitory computer-readable media of claim 11, the method further comprising receiving one or more modifications to the one or more answers in the grant application to obtain one or more modified answers, wherein providing the one or more answers to the grant application questions in the grant application document includes providing the one or more modified answers to the grant application questions in the grant application document.

13. The one or more non-transitory computer-readable media of claim 11 wherein the one or more documents are one or more first documents, and further comprising:
receiving multiple second documents;
receiving a selection of one or more second documents as the one or more first documents; and
identifying the one or more second documents as the one or more first documents.

14. The one or more non-transitory computer-readable media of claim 11, the method further comprising:
receiving an expected funding amount for the grant application;
receiving a status of the grant application;
storing the expected funding amount for the grant application and the status of the grant application in association with the grant application; and
providing for display an identifier of the grant application, the expected funding amount for the grant application, and the status of the grant application.

15. The one or more non-transitory computer-readable media of claim 14 wherein the grant application is a first grant application, and the method further comprises:
determining a total number of grant applications, the total number of grant applications including the first grant application and one or more second grant applications;
determining a total expected funding amount of the grant applications, the total expected funding amount of the grant applications including the expected funding amount for the first grant application and one or more expected funding amounts for the one or more second grant applications; and
providing for display the total number of grant applications, the total expected funding amount of the grant applications, the identifier of the first grant application, and one or more identifiers of the one or more second grant applications.

16. The one or more non-transitory computer-readable media of claim 11, the method further comprising:
receiving a request from a first user to share the grant application with a second user; and
sharing the grant application with the second user.

17. The one or more non-transitory computer-readable media of claim 11 wherein the grant application document includes a Hypertext Markup Language document (HTML document) that is provided by a grant application website.

18. The one or more non-transitory computer-readable media of claim 17 wherein obtaining the grant application questions from the grant application document includes obtaining the grant application questions from the HTML document at the grant application website and providing the one or more answers to the grant application questions in the grant application document includes providing the one or more answers to the grant application questions in the HTML document at the grant application website.

19. The one or more non-transitory computer-readable media of claim 17, the method further comprising:
utilizing one or more Document Object Models (DOMs) of the HTML document to obtain the grant application questions; and
utilizing the one or more DOMs to automatically provide the one or more answers to the grant application questions in the HTML document.

20. The one or more non-transitory computer-readable media of claim 19 wherein utilizing the one or more DOMs of the HTML document to obtain the grant application questions includes:
generating a data structure that includes one or more iframes of the HTML document that meet one or more criteria; and
utilizing the one or more iframes in the data structure to obtain at least one of the grant application questions.

21. The one or more non-transitory computer-readable media of claim 11 wherein the grant application document includes one of a Portable Document Format (PDF) document and a document file format document.

22. A system comprising at least one processor and at least one memory including executable instructions that when executed by the at least one processor cause the system to:
receive a request to obtain application questions in an application document;
obtain the application questions from the application document;
generate an application that includes the application questions;
receive one or more documents, the one or more documents including information usable to answer at least some of the application questions;
receive a request to have an artificial intelligence model system generate one or more answers to at least some of the application questions;
generate, based on the request to have the artificial intelligence model system generate the one or more answers, one or more inputs to the artificial intelligence model system;
provide the one or more inputs and the one or more documents to the artificial intelligence model system;
receive one or more responses to the one or more inputs, the one or more responses including the one or more answers, the one or more answers generated by the artificial intelligence model system using the one or more documents;
provide the one or more answers in the application;
receive a request to provide the one or more answers to the application questions in the application document; and
provide the one or more answers to the application questions in the application document.

23. The system of claim 22 wherein the application document is one of a grant application document, an employment application document, an education application document, and a housing application document.

24. The system of claim 22 wherein the application document includes a Hypertext Markup Language document (HTML document) that is provided by an application website.

25. The system of claim 24 wherein the executable instructions that when executed by the at least one processor further cause the system to:
utilize one or more Document Object Models (DOMs) of the HTML document to obtain the application questions; and
utilize the one or more DOMs to automatically provide the one or more answers to the application questions in the HTML document.

26. The system of claim 25 wherein the executable instructions that when executed by the at least one processor that further cause the system to utilize the one or more DOMs of the HTML document to obtain the application questions include executable instructions that when executed by the at least one processor further cause the system to:
generate a data structure that includes one or more iframes of the HTML document that meet one or more criteria; and
utilize the one or more iframes in the data structure to obtain at least one of the application questions.
